(19) United States
(12) Patent Application Publication
(10) Pub. No.: US 2012/0208166 A1
(43) Pub. Date: Aug. 16, 2012

(54) System and Method for Adaptive Knowledge Assessment And Learning

(76) Inventors: Steve Ernst, (US); Charles J. Smith, (US); Gregory Klinkel, (US); Robert Burgin, (US)

(21) Appl. No.: 13/029,045

(22) Filed: Feb. 16, 2011

(51) Int. Cl. G09B 7/00

(52) U.S. Cl. 434/353

(57) ABSTRACT

A system and method of knowledge assessment comprises displaying to a learner a plurality of multiple-choice questions and two-dimensional answers, accessing a database of learning materials, and transmitting to the learner the plurality of multiple-choice questions and two-dimensional answers. The answers includes plurality of full-confidence answers consisting of single-choice answers, a plurality of partial-confidence answers consisting of one or more sets of multiple single-choice answers, and an unsure answer. The method further comprises scoring a confidence-based assessment (CBA) administered to the learner by assigning various knowledge state designations based on the learner's responses to the two-dimensional questions.

### RELATED APPLICATIONS

This application is related to U.S. patent application Ser. No. 12/908,303, filed on Oct. 20, 2010, U.S. patent application Ser. No. 10/398,625, filed on Sep. 23, 2003, U.S. patent application Ser. No. 11/187,606, filed on Jul. 23, 2005, and U.S. Pat. No. 6,921,268, issued on Jul. 26, 2005. The details of each of the above listed applications are hereby incorporated by reference into the present application by reference and for all proper purposes.

### FIELD OF THE INVENTION

Aspects of the present invention relate to knowledge assessment and learning and to microprocessor and networked based testing and learning systems. Aspects of the present invention also relate to knowledge testing and learning methods, and more particularly, to methods and systems for Confidence-Based Assessment (“CBA”) and Confidence-Based Learning (“CBL”), in which a single answer from a learner generates two metrics with regard to the individual's confidence and correctness in his or her response. Novel systems and methods in accordance with this process facilitate an approach for tightly coupling formative assessment and learning, and therefore immediate remediation in the learning process. In addition, the novel systems and methods encompassed within this process provide an adaptive and personalized learning methodology for each learner.

### BACKGROUND

Traditional multiple-choice testing techniques to assess the extent of a person's knowledge in a subject matter include varying numbers of possible choices that are selectable by one-dimensional or right/wrong (RW) answers. A typical multiple-choice test might include questions with three possible answers, where generally one of such answers can be eliminated by the learner as incorrect as a matter of first impression. This gives rise to a significant probability that a guess on the remaining answers could result in a response marked as correct that may or may not be correct. Under this situation, a successful guess would mask the true extent or the state of knowledge of the learner, as to whether he or she is informed (i.e., confident with a correct response), misinformed (i.e., confident in the response, which response, however, is not correct) or being lacked of information (i.e., the learner explicitly states that he or she does not know the correct answer, and is allowed to respond in that fashion). Accordingly, the traditional multiple-choice one-dimensional testing technique is highly ineffectual as a means to measure the true extent of knowledge of the learner. Despite this significant drawback, the traditional one-dimensional, multiple-choice testing techniques are widely used by information-intensive and information-dependent organizations such as banking, insurance, utility companies, educational institutions and governmental agencies.

Traditional multiple-choice, one-dimensional (right/wrong), testing techniques are forced-choice tests. This format requires individuals to choose one answer, whether they know the correct answer or not. If there are three possible answers, random choice will result in a 33% chance of scoring a correct answer. One-dimensional scoring algorithms usually reward guessing. Typically, wrong answers are scored as zero points, so that there is no difference in scoring between not answering at all and taking an unsuccessful guess. Since guessing sometimes results in correct answers, it is always better to guess than not to guess. It is known that a small number of traditional testing methods provide a negative score for wrong answers, but usually the algorithm is designed such that eliminating at least one answer shifts the odds in favor of guessing. So for all practical purposes, guessing is still rewarded.

In addition, one-dimensional testing techniques encourage individuals to become skilled at eliminating possible wrong answers and making best-guess determinations at correct answers. If individuals can eliminate one possible answer as incorrect, the odds of picking a correct answer reach 50%. In the case where 70% is passing, individuals with good guessing skills are only 20% away from passing grades, even if they know almost nothing. Thus, the one-dimensional testing format and its scoring algorithm shift the purpose of individuals, their motivation, away from self-assessment and receiving accurate feedback, and toward inflating test scores to pass a threshold.

Confidence-Based Assessments, on the other hand, are designed to eliminate guessing and accurately assess people's true state of knowledge

Aspects of the present invention build upon the Confidence-Based Assessment (“CBA”) and Confidence-Based Learning (“CBL”) Systems and methods disclosed in U.S. patent application Ser. No. 12/908,303, U.S. patent application Ser. No. 10/398,625, U.S. patent application Ser. No. 11/187,606, and U.S. Pat. No. 6,921,268, all of which are incorporated into the present application by reference and all of which are owned by Knowledge Factor, Inc. of Boulder Colo. This Confidence-Based Assessment approach is designed to eliminate guessing and accurately assess a learner's true state of knowledge. The CBA and CBL format (collectively referred to as “CB”) covers three states of mind: confidence, doubt, and ignorance. Individuals are not forced to choose a specific answer, but rather they are free to choose one answer, two answers, or state that they do not know the answer. The CB answer format more closely matches the states that test takers actually think and feel. Individuals quickly learn that guessing is penalized, and that it is better to admit doubts and ignorance than to feign confidence. Moreover, since CBA discourages guessing, test takers shift their focus from test-taking strategies and trying to inflate scores, toward honest, self-assessment of their actual knowledge and confidence. In fact, the more accurately and honestly individuals self-assess their own knowledge and feelings of confidence, the better their numerical scores.

The prior applications and systems described and incorporated by reference above are described here for ease of reference. As shown in FIG. 1, a prior art knowledge assessment method and learning system 5 provides a distributed information reference testing and learning solution 10 to serve the interactive needs of its users. Any number of users may perform one function or fill one role only while a single user may perform several functions or fill many roles. For example, a system administrator 12 may perform test assessment management, confirm the authenticity of the users 14, deliver the test queries to multiple users 14 who may includes learners, (by password, fingerprint data or the like), and monitor the test session for regularity, assessment and feedback Likewise, the system users 14 provide authentication to the administrator 12 and take the test. A help desk 16, which might be stationed by appropriate personnel, is available to the users 14 for any problems that might arise. A content developer 18, or test author, designs and produces the test content and/or associated learning content.

FIGS. 2 and 3 show one embodiment of a computer network architecture that may be used to effect the distribution of the knowledge assessment and learning functions, and generally encompasses the various functional steps, as represented by logical block 100 in FIG. 3. Knowledge assessment queries or questions are administered to the learners of each registered organization through a plurality of subject terminals 20-1, 2 . . . n, and 22-1, 2 . . . n. One or more administrator terminals 25-1, 26-1 are provided for administering the tests from the respective organizations. Each subject terminal 20, 22 and Administrator Terminal 25, 26 is shown as a computer workstation that is remotely located for convenient access by the learners and the administrator(s), respectively. Communication is effected by computer video screen displays, input devices such as key board, touch pads, “game pads,” mobile devices, mouse, and other devices as known in the art. Each subject terminal 20, 22 and administrator Terminal 25, 26 preferably employs sufficient processing power to deliver a mix of audio, video, graphics, virtual reality, documents, and data.

Groups of learner terminals 20, 22 and administrator terminals 25, 26 are connected to one or more network servers 30 via network hubs 40. Servers 30 are equipped with storage facilities such as RAID memory to serve as a repository for subject records and test results.

As seen in FIG. 2, local servers 30-1, 30-2 are connected in communication to each other and to a courseware server 30-3. As illustration of the system's remote operability, the server connections are made through an Internet backbone 50 by conventional Router 60. Information transferred via Internet backbone 50 is implemented via industry standards including the Transmission Control Protocol/Internet Protocol (“TCP/IP”).

Courseware, or software dedicated to education and training and administrative support software are stored and maintained on courseware server 30-3 and preferably conforms to an industry standard for distributed learning model (the ADL initiative), such as the Aviation Industry CBT Committee (AICC) or Sharable Content Object Reference Model (SCORM) for courseware objects that can be shared across systems. Courseware server 30-3 supports and implements the software solution of the present invention, including the functional steps as illustrated in FIG. 3. The software can be run on subject terminals 20, 22, which is subject to the independent controlled by an administrator. The system 8 provides electronic storage facilities for various databases to accommodate the storage and retrieval of educational and learning materials, test contents and performance and administration-related information.

In operation, any remotely located learner can communicate via a subject terminal 20, 22 with any administrator on an administrator terminal. The system 8 and its software provides a number of web-based pages and forms, as part of the communication interface between a user (including system administrator 12, learner 14 and test content developer 18) and the system to enable quick and easy navigation through the knowledge assessment process. A Web-based, browser-supported home page of the knowledge assessment and learning system of the present invention is presented to the system user, which serves as a gateway for a user to access the system's Web site and its related contents. The homepage includes a member (user) sign-in menu bar, incorporating necessary computer script for system access and user authentication. For illustrative purposes, the term “member,” is sometimes synonymously referred herein as “user.”

A member sign-in prompts system 8 to effect authentication of the user's identify and authorized access level, as generally done in the art.

Aspects provide a computer software-based means or test builder module 102 by which a user, such as a test administrator or a test content developer can construct a test.

For purposes of illustration, the test construction or building will herein be described with reference to a sample test that is accessible via the homepage with a “Build” option. The selection of this “Build” option leads to a test builder screen. The Test Builder main screen incorporates navigational buttons or other means to access the major aspects of test formulation. The test builder screen includes several functional software scripts in support of administrative tasks, such as accounting and user authentication, test creation, edit and upload, review of users' feedback statistics and provides a user's interface with system 8 for creating a new test. For purposes of discussion herein the test builder screen is also called “Create New Test Screen.”

Upon authentication of the user, system 8 leads the user to the test builder screen. The test builder screen prompts the user to fill in text boxes for information such as test identification, test name, and author identity, and initializes the test building module. Upon test initialization, the system provides the user with options for the input of test contents, by way of test creation, edition of existing test, upon test and or images.

System 8 further provides editorial and formatting support facilities in Hypertext Mark-Up Language (“HTML”) and other browser/software language to include font, size and color display for text and image displays. In addition, system 8 provides hyperlink support to associate images with questions and queries with educational materials.

As mentioned above, system 8 is adapted to allow the user to upload a rich-text format file for use in importing an entire test or portion thereof using the a number of Web-based pages and forms, as part of the communication interface between the user and the system. In addition, test builder module 102 is also adapted to receive an image file in various commonly used formats such as * .GIF and * .JPEG. This feature is advantageous as in the case where a test query requires an audio, visual and/or multi-media cue. Text and image uploading to the system is accomplished by the user activating a script or other means incorporated as part of the user interface or screen image. As part of the test builder (“Create New Test”) screen, a hyperlink is provided on the screen image, which activates a system script to effect the file transfer function via conventional file transfer protocols.

Test builder module 102 allows test authors to convert their existing tests or create new tests in the appropriate format. A test author inputs a question or query and a plurality of potential answers. Each question must have a designated answer as the correct choice and the other two answers are presumed to be wrong or misinformed responses. In the example as shown, each of the queries has three possible choices.

Once the body of a test has been constructed using the input facilities incorporated as part of the web pages presented to the User, test builder 102 configures the one-dimensional right-wrong answers to non-one dimensional answer format. Thus, in one embodiment of the present invention in which a query has three possible answers, a non-one-dimensional test, in the form of a two-dimensional answer is configured according to predefined confidence categories or levels. Three levels of confidence categories are provided, which are designated as: 100% sure (selects only one answer); 50% certain (select a pair of choices that best represents the answer (A or B) (B or C), or (A or C); and Unknown. For the 50% certain category, the answers are divided up into possible combination of pairs of choices (A or B) (B or C), or (A or C). The entire test is arranged with each query assigned by system 8 to a specified numbered question field and each answer assigned to a specified lettered answer field. The queries, confidence categories and the associated choices of possible answers are then organized and formatted in a manner that is adaptable for display on the user's terminal. Each possible choice of an answer is further associated with input means such as a point-and-click button to accept an input from the learner as an indication of a response to his or her selection of an answer. In one embodiment of the present invention, the presentation of the test queries, confidence categories and answers are supported by commonly used Internet-based browsers. The input means can be shown as separate point-and-click buttons adjacent each possible choice of answer. Alternatively, the input means can be embedded as part of the answer choice display, which is activated when the learner points and clicks on the answer.

As, seen from the above discussion, the system substantially facilities the construction of non-one-dimensional queries or the conversion of traditional one-dimensional or “RW” queries. The test and learning building function of the present invention is “blind” to the nature of the test materials on which the test is constructed. For each query or question, the system would only need to act upon the form of the test query but not its contents; possible answers and correct answer; and the answer choice selected by the learner.

Test builder 102 also allows a user to link each query to specific learning materials or information pertaining to that query. The materials are stored by the system, providing ready access to the user as references for text construction. They also form a database to which the learner is directed for further training or reeducation based on the performance of the knowledge assessment administered to the learner. These learning materials include text, animations, audio, video, web pages, and IPIX camera and similar sources of training materials. An import function as part of the test builder function is provided to accept these linked materials into the system.

Presentation of the knowledge assessment queries or tests to the learner is initiated by a “Display Test” or display test module 104. Supported by a computer script, display test module 104 includes administrative functions for authentication of each learner, notification of assessment session and for the retrieval of the queries from the system for visual presentation to the learner. Optionally, the queries may be presented in hypertext or other software language formats linkable by appropriate Uniform Resource Locators (“URL's”), as the administrator may determine, to a database of learning materials or courseware stored in system 8 or to other resources or Web sites.

As mentioned above, knowledge assessment of a learner is initiated by the presentation of the number of non-one-dimensional queries to the learner. Each of these queries is answerable as a response to a substantive multi-choice answer selectable from a predefined confidence category.

As an example of one embodiment, the test queries or questions would consist of three answer choices and a two-dimensional answering pattern that includes the learner's response and his or her confidence category in that choice. The confidence categories are: “I am sure,” “I am partially sure,” and “I don't know.” A query without any response is deemed as, and defaults to, the “I don't know” choice. In other embodiments, the “I don't know” choice is replaced with an “I Am Not Sure” choice.

Aspects of knowledge assessment can be administered to separate learners at different geographical locations and at different time periods. In addition, the knowledge assessment can be administered in real time, with test queries presented to the learner. The entire set of test queries can be downloaded in bulk to a learner's workstation, where the queries are answered in their entirety before the responses are communicated (uploaded) to the courseware server of system 8. Alternatively, the test queries can be presented one at a time with each query answered, whereupon the learner's response is communicated to the courseware server. Both methods for administering the knowledge assessment can optionally be accompanied by a software script or subroutine residing in the workstation or at the courseware server to effect a measurement of the amount of time for the subject to respond to any or all of the test queries presented. When so adapted, the time measuring script or subroutine functions as a time marker. In an exemplary embodiment of the present invention, the electronics time marker identifies the time for the transmission of the test query by the courseware server to the learner and the time when a response to the answer is returned to the server by the learner. Comparison of these two time markings yield the amount of time for the subject to review and respond to the test query.

When all queries have been answered, a “score your test” function is invoked, as by way of the learner clicking a “Score Your Test” button bar on the subject's workstation terminal or input device, which terminates the knowledge assessment session. System 8 initializes the operation of “Collect Responses” or collect responses module 106, which comprises computer software routine, to collect the learner's responses to the test queries. These responses are then organized and securely stored in a database of collected responses associated with system 8.

Thereafter, a scoring engine or comparison of responses module 108 (“Comparison of Responses”) is invoked to perform a “Comparison of responses to correct answer” on the subject's responses with the designated correct answers on which a gross score is calculated.

In prior systems, a scoring protocol is adopted, by which the learner's responses or answers are compiled using a predefined weighted scoring scheme. This weighted scoring protocol assigns predefined point scores to the learner for correct responses that are associated with an indication of a high confidence level by the learner. Such point scores are referred herein as true knowledge points, which would reflect the extent of the learner's true knowledge in the subject matter of the test query.

Conversely, the scoring protocol assigns negative point scores or penalties to the learner for incorrect responses that are associated with an indication of a high confidence level. The negative point score or penalty has a predetermined value that is significantly greater than knowledge points for the same test query. Such penalties are referred herein as misinformation points which would indicate that the learner is misinformed of the matter.

The point scores are passed to a scoring module 108, which calculates the learner's raw score, as well as other various other performance indices. System 8 further includes a “Prepare Learner feedback” module 110, which prepares such the performance data and prepare them to the learner via a “Prepare Learner Feedback” module 114. In a similar manner, a “Prepare Management Feedback” module 112 prepares the subject's performance data and prepare them to the test administrator via the “Management Feedback Module”116. In one embodiment of the present invention, these score components include raw score, a knowledge profile; aggregate score knowledge profile expressed as a percent score; self-confidence score; misinformation Gap; personal training plan; knowledge index; and performance rating.

As part of the feedback, system 8 organizes the test queries, which are presented to the learner or other system users based on the knowledge quality regions. System 8 uses the stored information created in module 102 that identifies specific curriculum for each question to create hyperlinks to that curriculum thus configuring a personal learning plan in relation to the quality regions. Thus, as soon as the test scores are calculated, the learner or the system user will be able to identify the area of information deficiencies where remedial actions are indicated.

The various tasks of the knowledge assessment and learning system are supported by any known network architecture and software solution. FIG. 4 presents a prior art flow diagram, which shows integrated test authoring, administration, tracking and reporting and associated databases that may be used with the new aspects disclosed herein.

As shown in FIG. 4, in support of test creation, a Test Builder page 202 is initiated by a test creator 204 with proper authentication identified in a creator user database DB 206. Database 206 is managed by creator supervisor 208. The test creator 204 provides content materials for the test queries, which are stored in test database, test DB 210. A test page 214 is created to incorporate test content materials from DB 210 and test assignment instructions from assignment DB 217. Assignment DB 217 includes functions such as administrative controls over the test contents, tests schedules and learner authentication. Assignment DB 217 is managed and controlled by reviewer supervisor 218.

Test queries are administered via test page 214 to one or more authenticated learners 216. As soon as the test has been taken, the results are compiled and passed on to a scoring program module 212 which calculates raw scores 232. The raw scores, as well as other performance data are stored as part of databases 235, 236 and 237. A test reviewer 226 generates a test score review page 222 using test result databases 235, 236, 237. Based on the analysis of the test score review page 222, the reviewer 226 may update the reviewer DB 224. The compiled and scored test results may then be reported immediately to the subjects and the subjects may be provided with their results 235, 236, 237 followed by answers with hyper-linked access to explanations for each question 234.

The structures described in association with these prior systems embodied about and in FIGS. 1-4 may also be utilized in conjunction with the new processes and systems disclosed in the present patent application and as described in more detail below.

Aspects of systems and methods in accordance with the present application further refine the Confidence-Based approach by incorporating additional aspects into a structured CBA and CBL format. After individuals complete a CBA or CBL, their set of answers are used to generate a knowledge profile. The knowledge profile presents information about the learning process to individuals and organizations as to the areas and degrees of mistakes (misinformation), unknowns, doubts and mastery.

### SUMMARY OF THE INVENTION

Aspects of the present invention provide a method and system for knowledge assessment and learning that accurately assesses the true extent of a learner's knowledge and provides learning or educational materials remedially to the subject according to identified areas of deficiency. The invention incorporates the use of Confidence Based Assessments and Learning techniques and is deployable on a microprocessor based computing device or networked communication client-server system.

Other aspects of devices and methods in accordance with the present invention provide a mechanism for personalized, adaptive assessment and learning where the content of the learning and assessment system is delivered to every learner in a personalized manner depending upon how each learner answers the particular questions.

In certain embodiments, these responses will vary depending on the knowledge, skill and confidence manifest by each learner, and the system and its underlying algorithms will adaptively feed future assessment questions and associated remediation depending on the knowledge quality provided by the learner for each question.

Another aspect of the invention is the use of a reusable learning object structure that provides a built-in mechanism to seamlessly integrate detailed learning outcome statements, subject matter that enables the learner to acquire the necessary knowledge and/or skills relative to each learning outcome statement, and a multi-dimensional assessment to validate whether the learner has actually acquired the knowledge and/or skills relative to each learning outcome statement along with his/her confidence in that knowledge or skills. The reusability of those learning objects is enabled through the content management system built into the invention such that authors can easily search for, identify, and re-use or re-purpose existing learning objects.

Other aspects of the invention encompasses an integrated reporting capability so that administrators, authors, registrars and authors can evaluate both the quality of the knowledge manifest by each user, and the quality of the learning materials as displayed in the learning objects. The reporting capability is highly customizable based on data stored in the database for each user response.

In accordance with another aspect, a system and method of knowledge assessment comprises displaying to a learner a plurality of multiple-choice questions and two-dimensional answers, accessing a database of learning materials, and transmitting to the learner the plurality of multiple-choice questions and two-dimensional answers. The answers include a plurality of full-confidence answers consisting of single-choice answers, a plurality of partial-confidence answers consisting of one or more sets of multiple single-choice answers, and an unsure answer. The method further comprises scoring a confidence-based assessment (CBA) administered to the learner by assigning various knowledge state designations based on the learner's responses to the two-dimensional questions.

### BRIEF DESCRIPTION OF THE DRAWINGS

FIG. 1 is a prior art conceptual design diagram showing the various participants to and interaction of the knowledge and misinformation testing and learning system according to aspects of the present invention.

FIG. 2 is a prior art perspective drawing of an exemplary computer network architecture that supports the method and system of aspects of the present invention.

FIG. 3 is a prior art logical block diagram of an embodiment of a testing and reporting structure according to aspects of the present invention;

FIG. 4 is a prior art flow diagram showing the network architecture and software solution to provide integrated test authoring, administration, tracking and reporting and associated databases according to aspects of the present invention;

FIG. 5 is a screen print illustrating a Question & Answer Format with seven response options according to aspects of the present invention;

FIG. 6 illustrates a general overview of the adaptive learning framework used in accordance with aspects of the present invention.

FIG. 6A-6C illustrate a round selection algorithm used in accordance with aspects of the present invention;

FIGS. 7A-7D illustrate examples of process algorithms used in accordance with aspects of the present invention that outline how user responses are scored, and how those scores determine the progression through the assessments and remediation;

FIG. 8 illustrates examples of the knowledge profiles generated by a system constructed in accordance with aspects of the present invention;

FIGS. 9-13 illustrate various reporting capabilities generated by a system constructed in accordance with aspects of the present invention;

FIG. 14 illustrates a three tiered application system architecture used in connection with aspects of the present invention;

FIG. 15 illustrates a machine or other structural embodiment that may be used in conjunction with aspects of the present invention; and

FIG. 16 illustrates the structure of reusable learning objects, how those learning objects are organized into modules, and how those modules are published for display to learners.

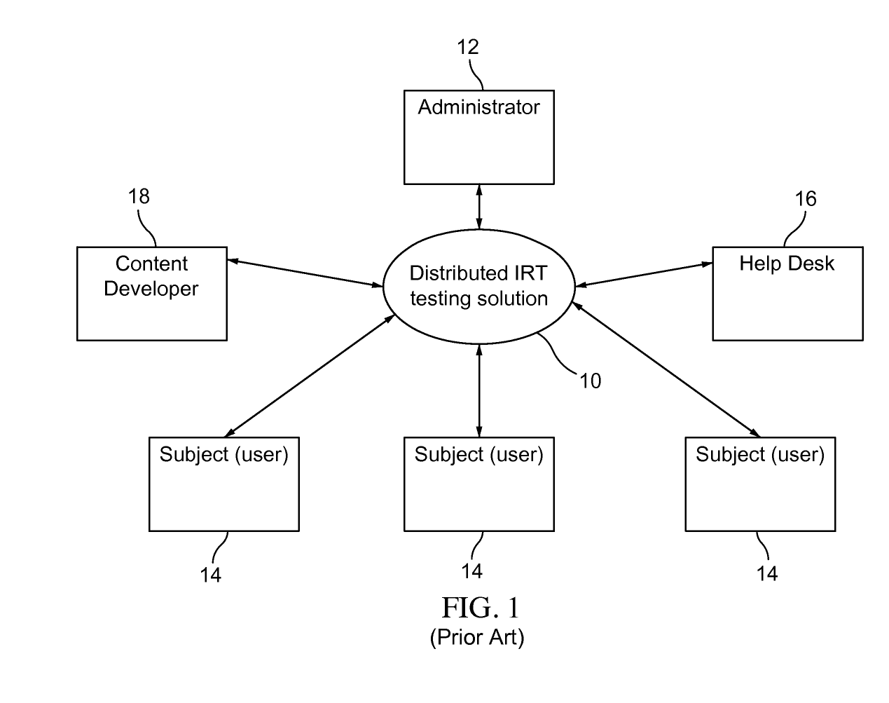

### DETAILED DESCRIPTION

Embodiments and aspects of the present invention provide a method and system for conducting knowledge assessment and learning. Various embodiments incorporate the use of confidence based assessment and learning techniques deployable on a micro-processor-based or networked communication client-server system, which extracts knowledge-based and confidence-based information from a learner. In a general sense the assessments incorporate non-one-dimensional testing techniques.

In accordance with another aspect, the present invention is a robust method and system for Confidence-Based Assessment (“CBA”) and Confidence-Based Learning (“CBL”), in which one answer generates two metrics with regard to the individual's confidence and correctness in his or her response to facilitate an approach for immediate remediation. This is accomplished through three primary tools:

1. A testing and scoring format that eliminates the need to guess at answers. This results in a more accurate evaluation of “actual” information quality.

2. A scoring method that more accurately reveals what a person: (1) accurately knows; (2) partially knows; (3) doesn't know; and (4) is sure that they know, but is actually incorrect.

3. A resulting knowledge profile that focuses only on those areas that truly require instructional or reeducation attention. This eliminates wasted time and effort training in areas where attention really isn't required.

In general, the foregoing tools are implemented by the follow method or “learning cycle”:

1. Take an assessment. This begins with the step of compiling a standard three answer (“A”, “B”, and “C”) multiple-choice test into a structured CBA format with seven possible answers for each question that cover three states of mind: confidence, doubt, and ignorance, thereby more closely matching the state of mind of the test taker.

2. Review the knowledge profile. Given a set of answers a CBA scoring algorithm is implemented that teaches the learner that guessing is penalized, and that it is better to admit doubts and ignorance than to feign confidence. The CBA set of answers are then compiled and displayed as a knowledge profile to more precisely segment answers into meaningful regions of knowledge, giving individuals and organizations rich feedback as to the areas and degrees of mistakes (misinformation), unknowns, doubts and mastery. The knowledge profile is a much better metric of performance and competence, especially in the context of the corporate training environment where it encourages better-informed, higher information quality, employees reducing costly knowledge and information errors, and increasing productivity.

3. Review the question, answer, and explanation with regard to the material.

4. Review further training and information links to gain a better understand of the subject material.

5. Iteration—The process can be repeated as many times as the individual needs to in order to gain an appropriate understanding of the content. As part of this iterative model, answers scored as confident and correct (depending on which algorithm is used) can be removed from the list of questions presented to the learner so that the learner can focus on his/her specific skill gap(s). During each iteration, the number of questions presented to the learner can be represented by a subset of all questions in an ampModule; this is configurable by the author of the ampModule. In addition, the questions, and the answers to each question, are presented in random order during each iteration through the use of a random number generator invoked within the software code that makes up the system.

In accordance with one aspect, the invention produces a knowledge profile, which includes a formative and summative evaluation for the system user and identifies various knowledge quality levels. Based on such information, the system correlates, through one or more algorithms, the user's knowledge profile to a database of learning materials, which is then communicated to the system user or learner for review and/or reeducation of the substantive response.

Interactive accommodation of various aspects of test administration and learning by a system user including storage of information and learning materials, test or query creation, editing, scoring, reporting and learning.

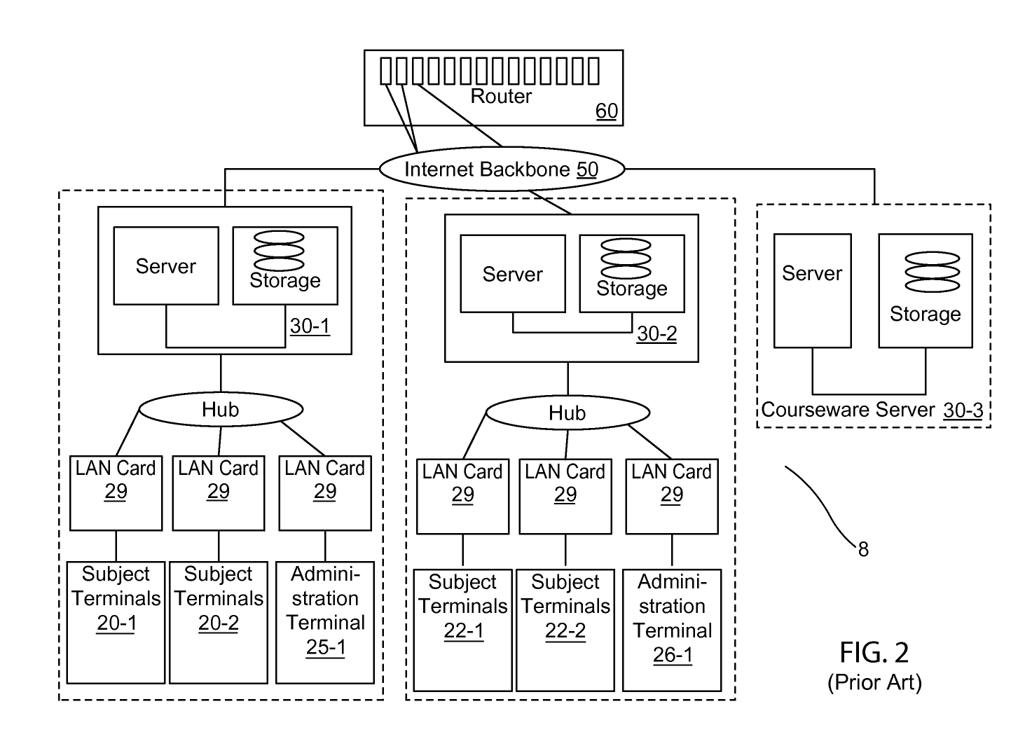

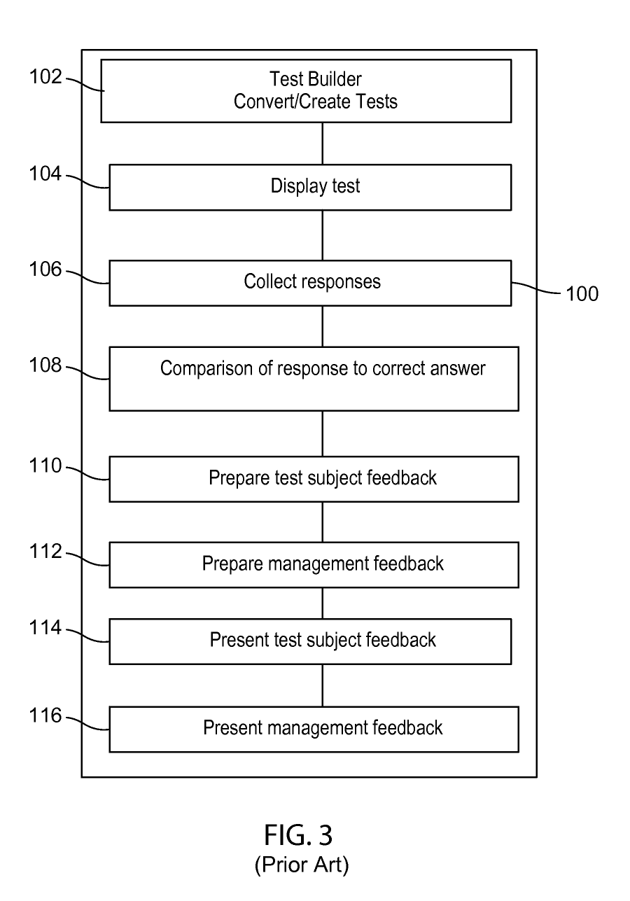

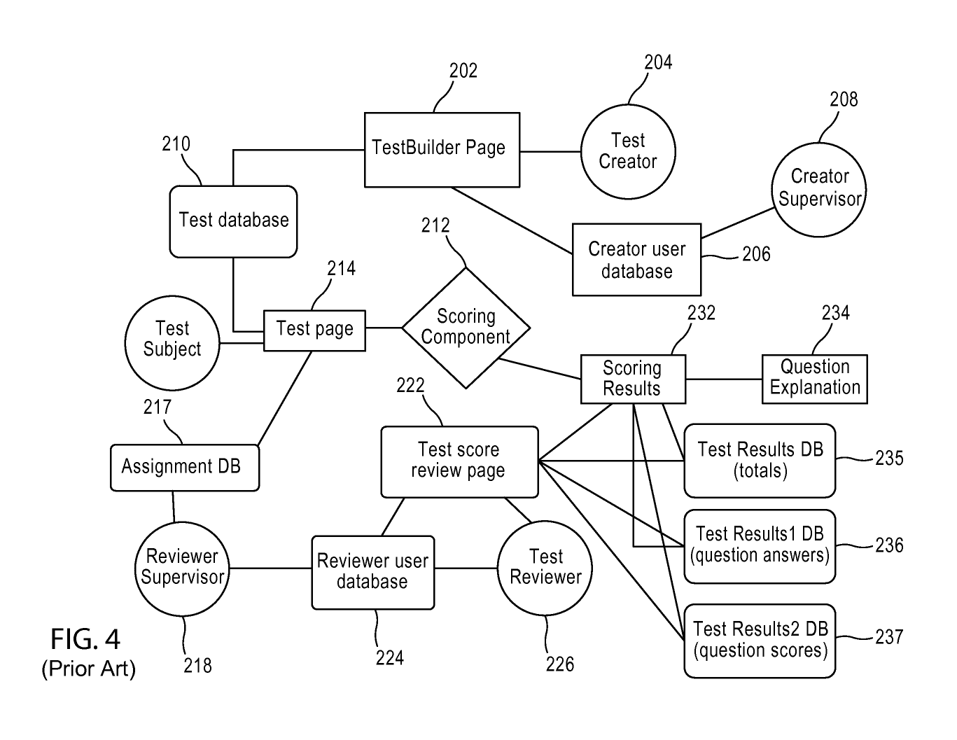

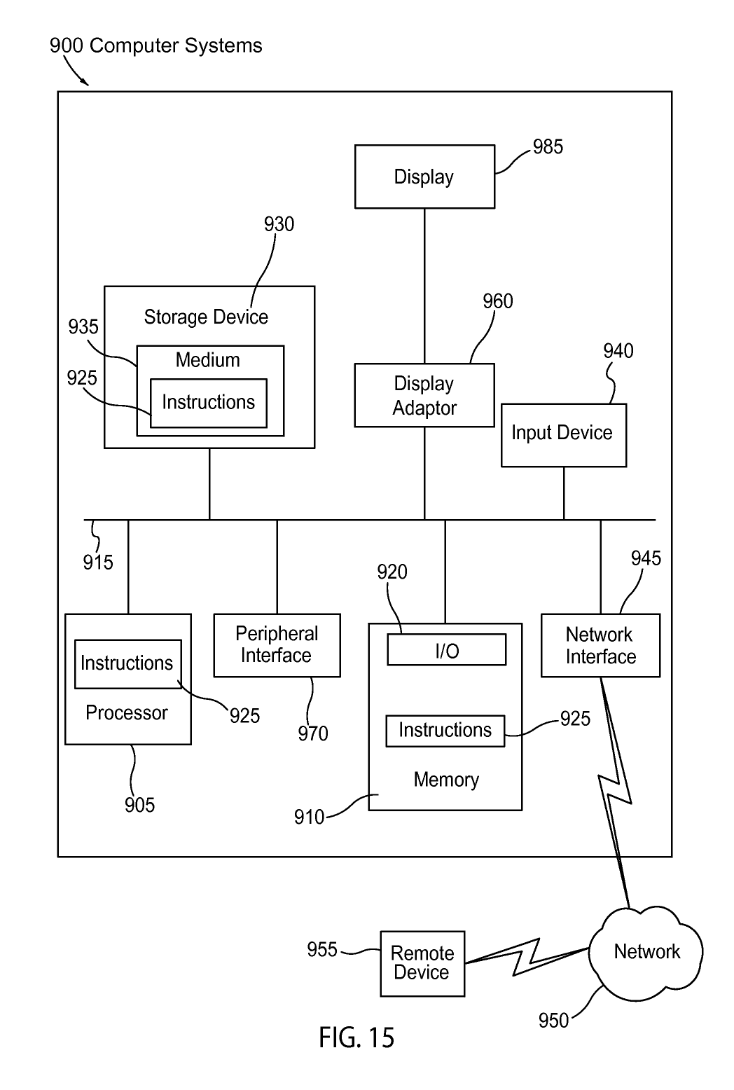

Aspects of the present invention are adaptable for deployment on a standalone personal computer system. In addition, they are also deployable on a computer network environment such as the World Wide Web, or an intranet client-server system, in which, the “client” is generally represented by a computing device adapted to access the shared network resources provided by another computing device, the server. See for example the network environments described in conjunction with FIGS. 2 and 15. Various database structures and application layers are incorporated to enable interaction by various user permission levels, each of which is described more fully herein.

In accordance with other aspects of a system constructed in accordance with the present invention, one or more of the following features may also be incorporated. In the following discussion certain terms of art are used for ease of reference but it is not the intention here to limit the scope of these terms in any way other than as set forth in the claims.

ampUnit—refers to an individual question/answer presented to a learner or other user of the assessment and learning system.

ampModule—refers to a group of ampUnits (e.g. questions and answers) that are presented to a learner in any given testing/assessment situation.

### Compiling the CBA Test and Scoring Format

To build, develop or otherwise compile a test in a CBA format entails converting a standard multiple-choice test comprising three answer (“A”, “B”, and “C”) multiple-choice questions into questions answerable by seven options, that cover three states of mind: confidence, doubt, and ignorance.

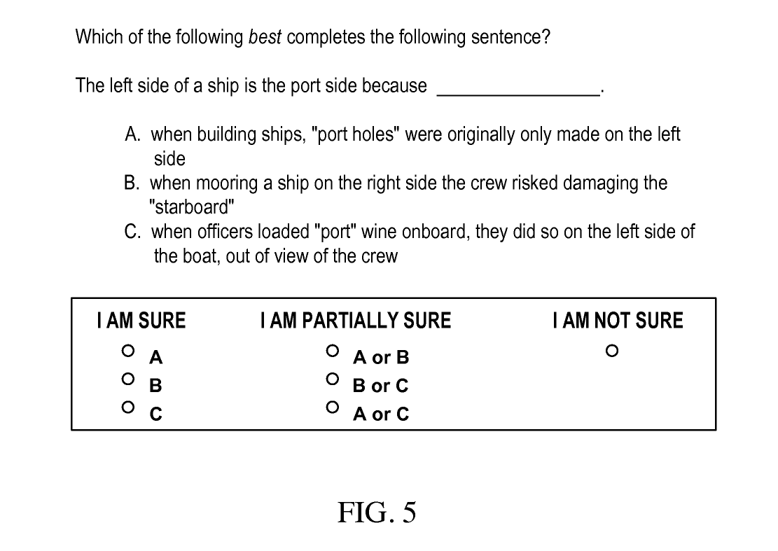

FIG. 5 is a screen print illustrating such a Question & Answer Format with seven response options. In response to the question presented, the learner is required to provide two-dimensional answers indicating both their substantive answer and level of confidence in their choice. In the example of FIG. 5, the one-dimensional choices are listed under the question. However, the learner is also required to answer in a second dimension, which are categorized under headings “I Am Sure”; “I Am Partially Sure” and “I Am Not Sure”. The “I Am Sure” category includes the three single-choice answers (A-C). The “I Am Partially Sure” category allows the subject to choose between sets of any two single-choice answers (A or B, B or C, A or C). There is also an “I Am Not Sure” category that includes one specific “I Am Not Sure” answer. The three-choice seven-answer format is based on research that shows that fewer than three choices introduces error by making it easier to guess at an answer and get it right. More than three choices can cause a level of confusion (remembering previous choices) that negatively impacts the true score of the test.

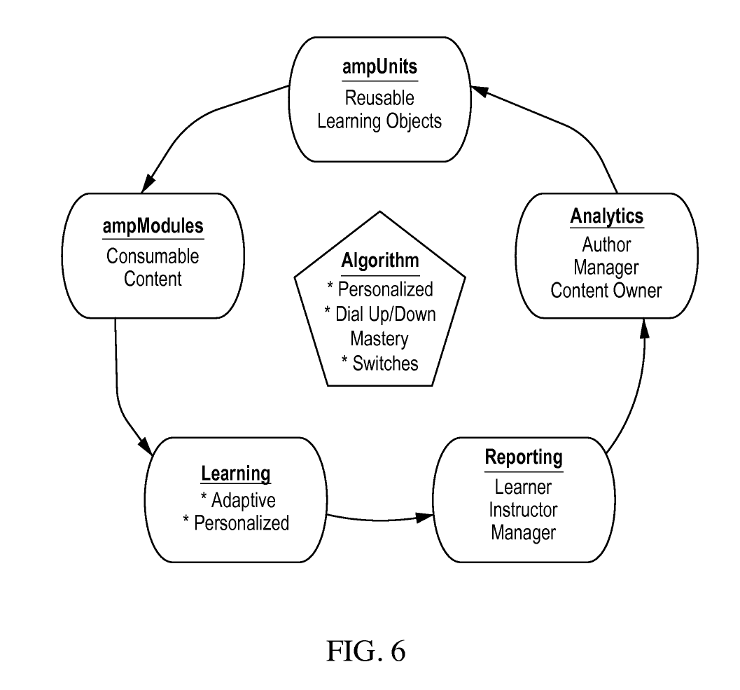

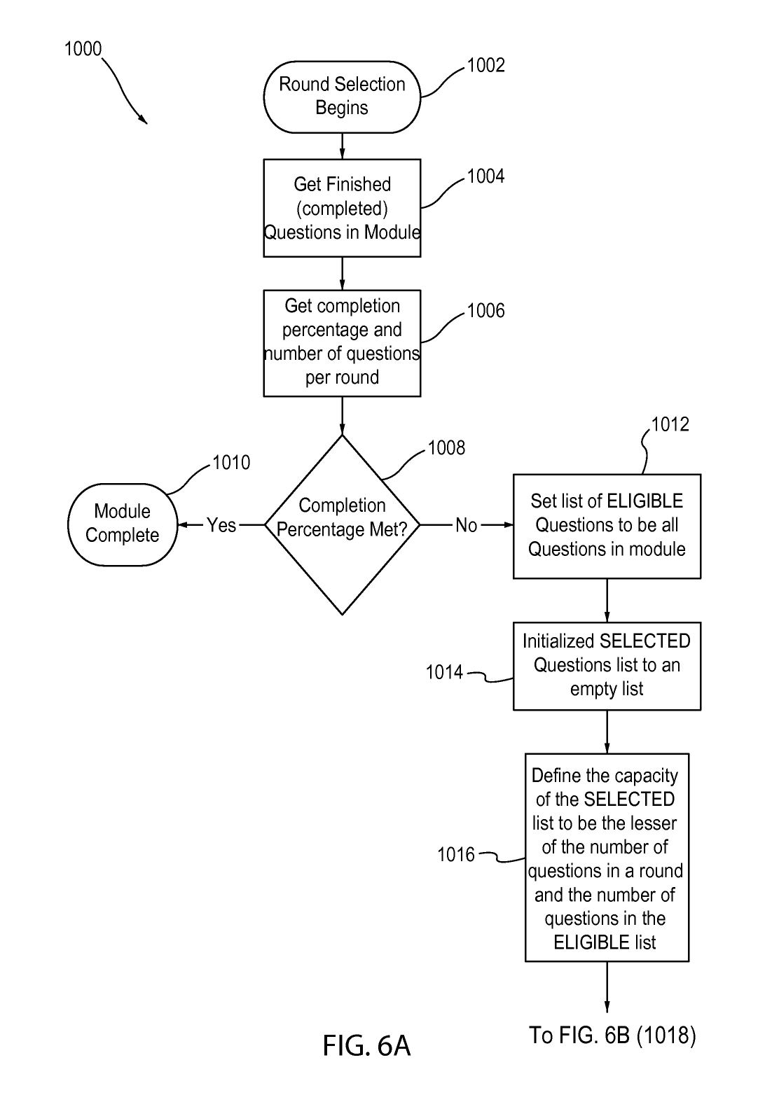

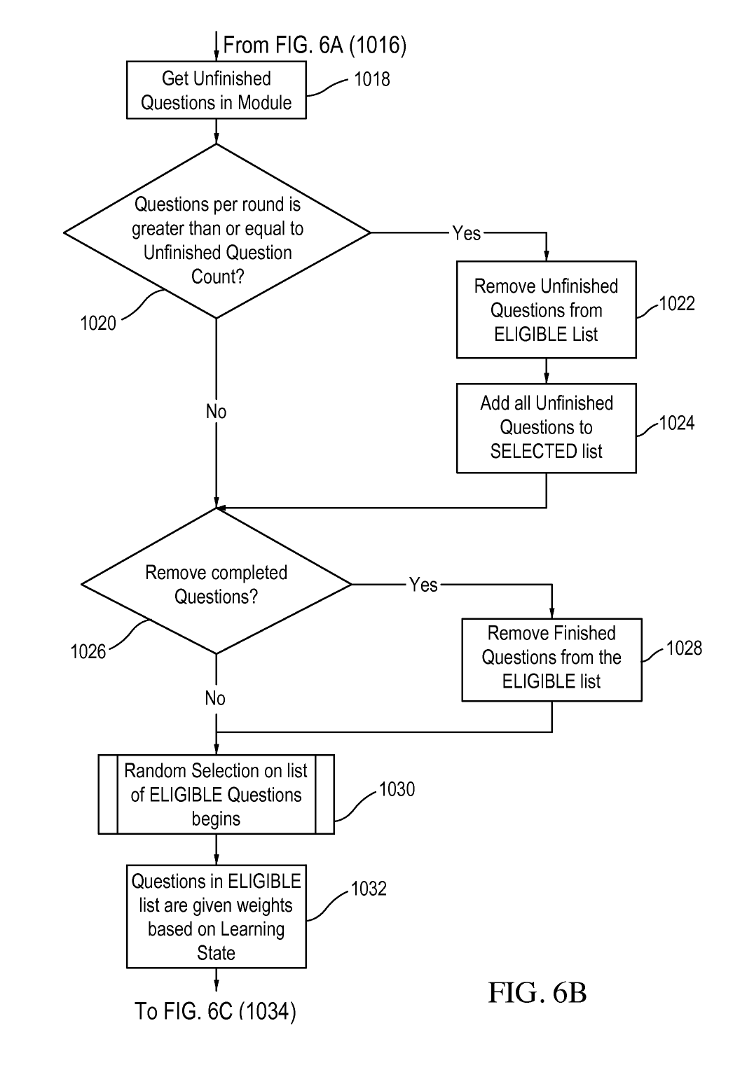

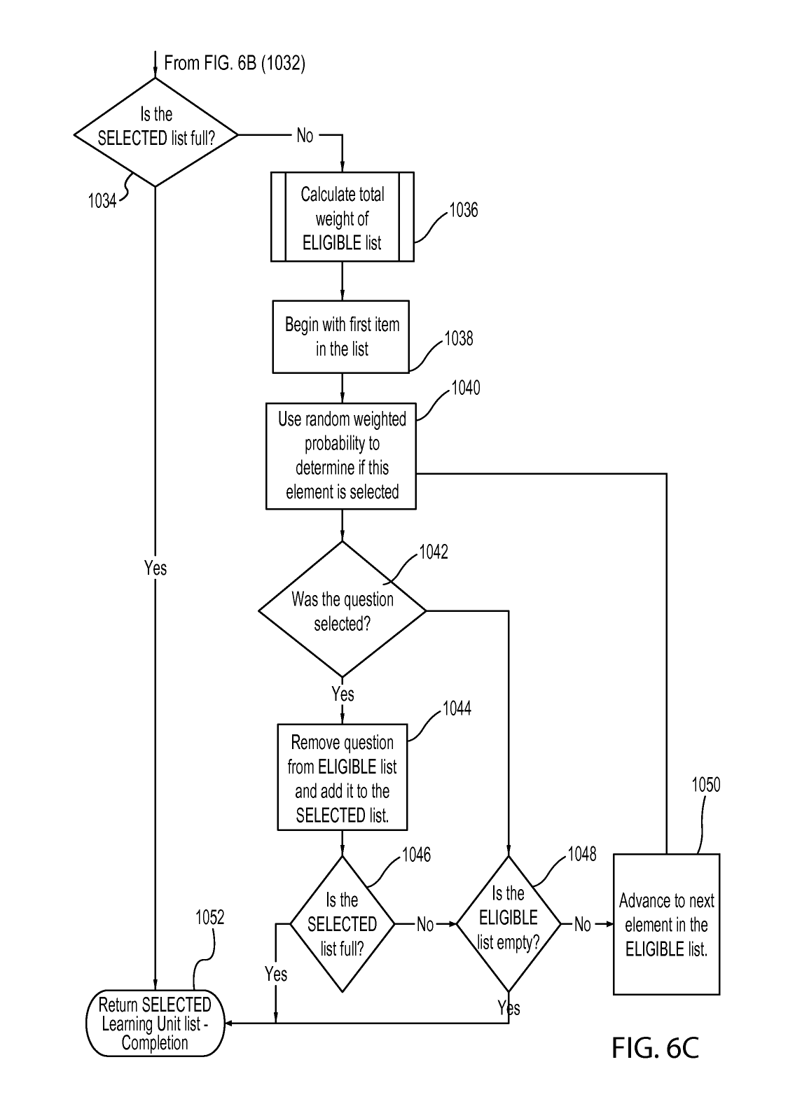

FIG. 6 illustrates a high-level overview of the adaptive learning framework structure embodied in aspects of the present invention. The overall methods and systems in accordance with the aspects disclosed herein adapt in real-time by providing assessment and learning programs to each learner as a function of the learner's prior responses. In accordance with other aspects of the present invention, the content of the learning and assessment system is delivered to every learner in a personalized manner depending upon how each learner answers the particular questions. Specifically, those responses will vary depending on the knowledge, skill and confidence manifest by each learner, and the system and its underlying algorithms will adaptively feed future assessment questions and associated remediation depending on the knowledge quality provided by the learner for each question.

### Increasing Retention by Iteration

A learner's confidence is highly correlated with knowledge retention. As stated above, the present method asks and measures a learner's level of confidence. However, it moves further by moving subjects to full confidence in their answers in order to reach true knowledge, thereby increasing knowledge retention. This is accomplished in part by an iteration step. After individuals review the results of the material in CBA as above, learners can retake the assessment, as many times as necessary to reach true knowledge. This yields multiple Knowledge Profiles which help individuals understand and measure their improvement throughout the assessment process.

In one embodiment, when an individual retakes an assessment, the questions are randomized, such that individuals do not see the same questions in the same order from the previous assessment. Questions are developed in a database in which there is a certain set of questions to cover a subject area. To provide true knowledge acquisition and testing of the material, a certain number of questions are presented each time rather than the full bank of questions. This allows the individuals to develop and improve with their understanding of the material over time.

Display of ampUnits (Questions) to Learners

In the prior art embodiments discussed above, questions are displayed to the user in their entirety (all questions at once in a list) and the user also answers the questions in their entirety. In another embodiment described here, the questions are displayed one at a time. In accordance with further embodiments, learning is enhanced by an overall randomization of the way questions are displayed to a user. Broadly speaking, the selected grouping of questions allows the system to better tailor the learning environment to a particular scenario. As set forth above. in some embodiments the questions and groups of questions are referred as ampUnits and ampModules respectively. In one embodiment, the author may configure whether the ampUnits are “chunked” or otherwise grouped so that only a portion of the total ampUnits in a given ampModule are presented in any given round of learning. The ampUnits may also be presented in a randomized order to the user in each round or iteration of learning. The author of the learning system may select that answers within a given ampUnit are always displayed in random order during each round of learning. The randomization of question presentation may be incorporated into both the learning and assessment portions of the learning environment.

Aspects here will use a weighing system to determine the probability of a question being displayed in any given round based on how the ampUnit was previously answered. In one embodiment, there is a higher probability that a particular question will be displayed if it was answered incorrectly in a previous round. FIGS. 6A-6C illustrates a round selection algorithm and process flow in accordance with aspects of the present invention.

With continuing reference to FIGS. 6A-6C, an algorithmic flow 1000 is shown that in general describes one embodiment of the logic utilized in accordance with question selection during a particular round of learning. Descriptions of each of the steps 1002-1052 are included within the flow chart and the logic steps are illustrated at the various decision nodes within the flow chart to show the process flow.

### Point Scoring and Testing Evaluation Algorithms

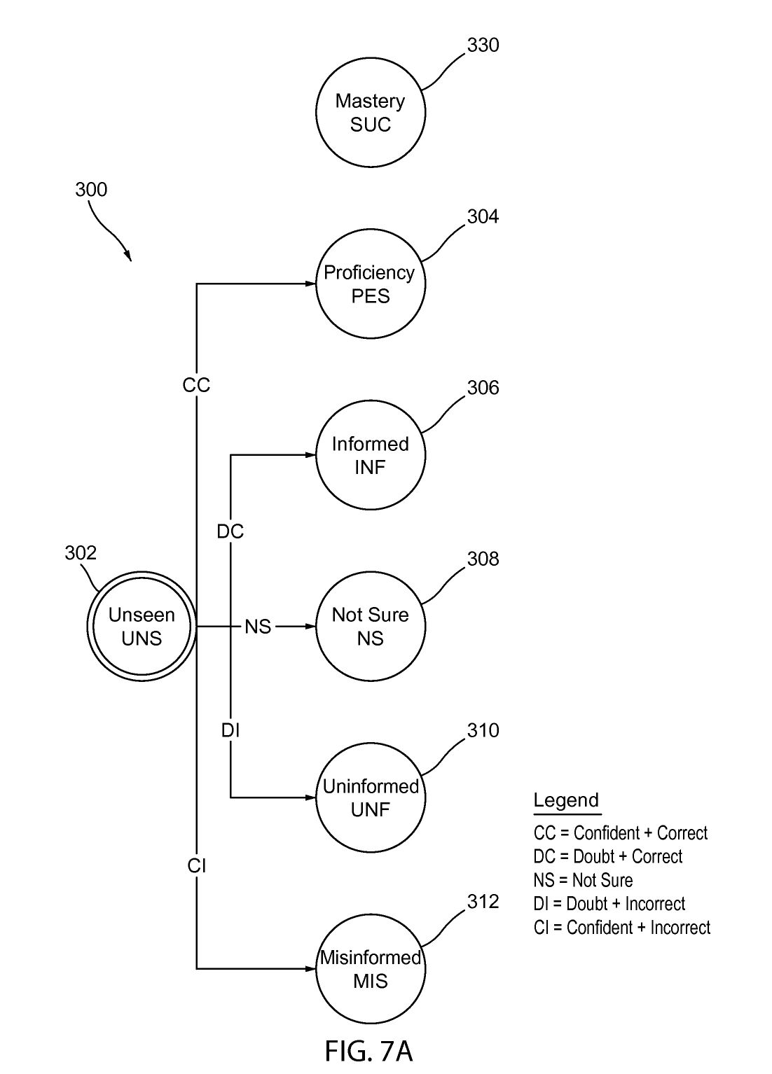

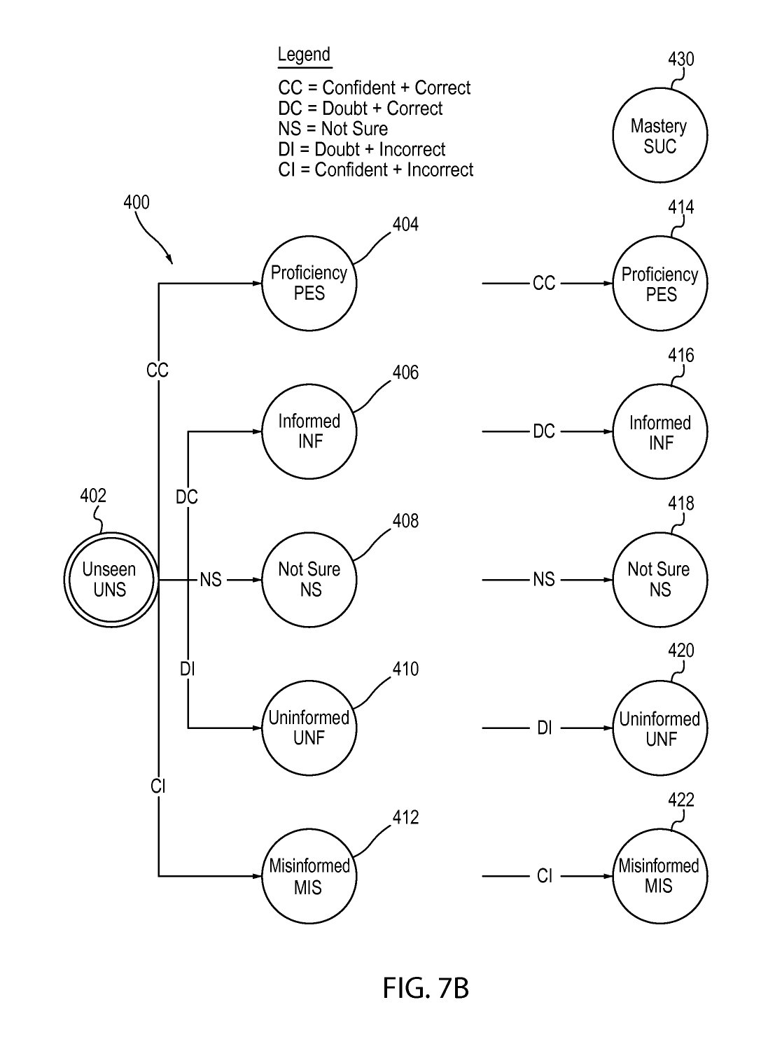

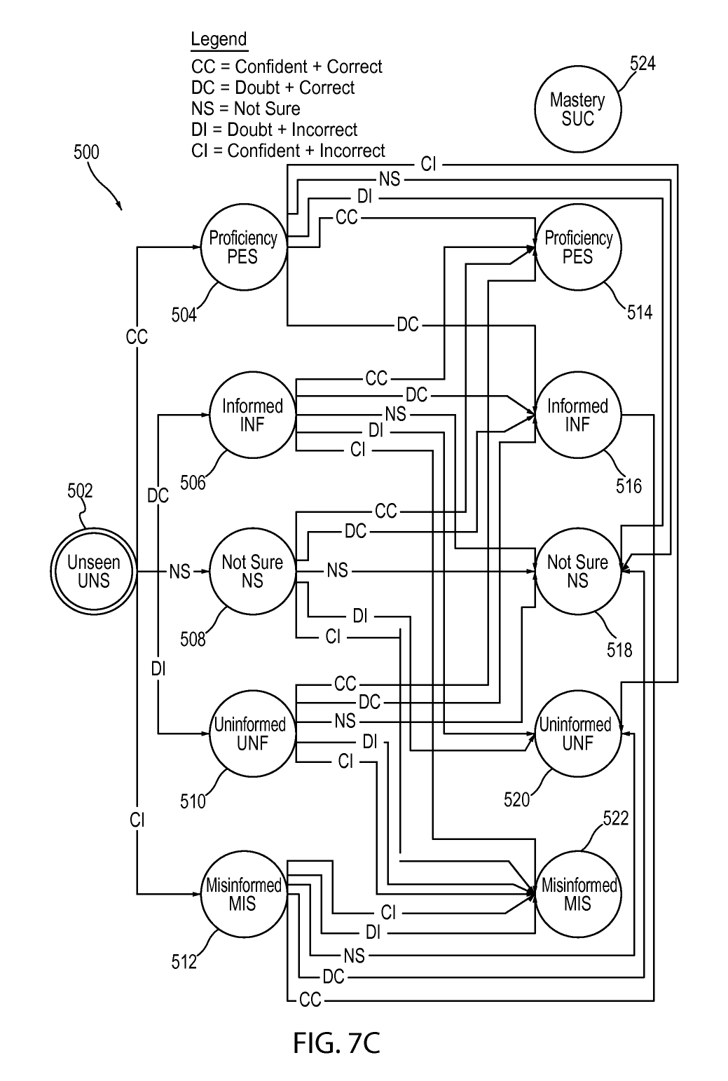

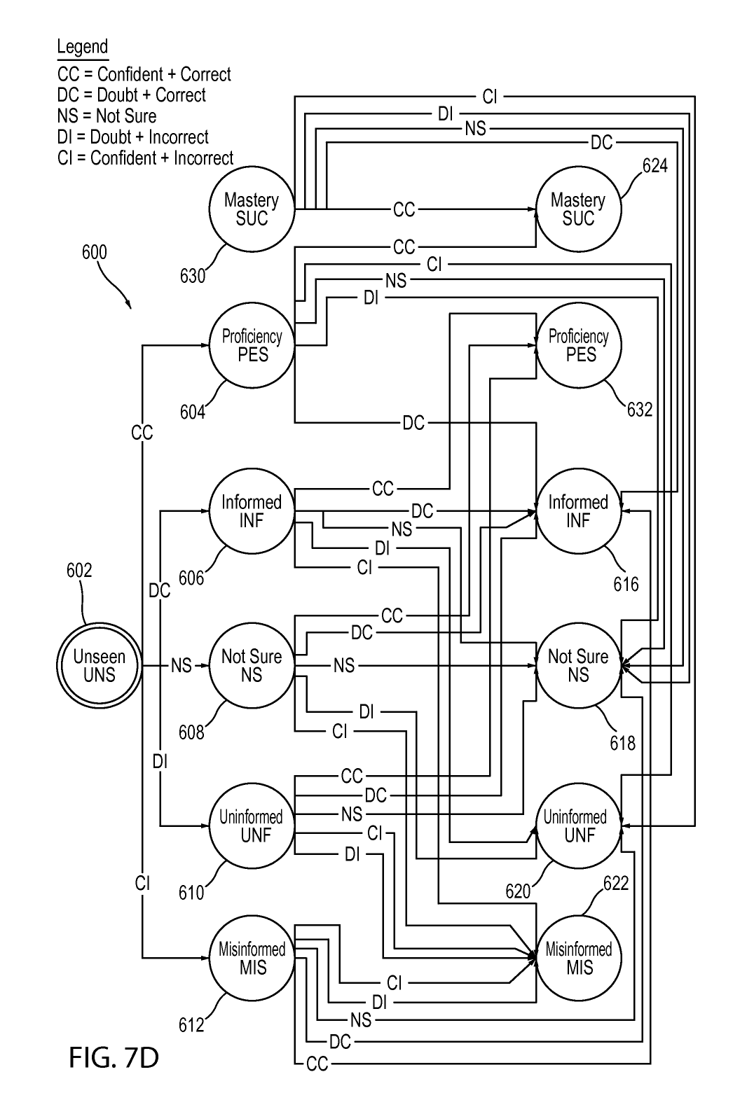

Aspects relating to the implementation of the knowledge assessment and testing system invoke various novel algorithms to evaluate and score a particular testing environment. FIGS. 7A-7D illustrate algorithmic flow charts that illustrate four “goal state” schemes for knowledge assessment and learning. FIG. 7A shows an initial assessment scheme, FIG. 7B shows a direct scoring scheme, FIG. 7C shows a “one time correct” proficiency scheme, FIG. 7D shows a “twice correct” mastery scheme. Each of these goal states are determined by an author or administrator of the system as the appropriate goal for a learner in a particular testing session. In FIGS. 7A-7D, the following nomenclature is used to describe any particular response to a question: CC=confident & correct, DC=doubt & correct, NS=not sure, DI=doubt & incorrect, CI=confident & incorrect.

With reference first to FIG. 7A, an assessment algorithm 300 is displayed where an initially unseen question (UNS) is presented to a learner at 302. Depending on the response from the learner, an assessment is made as to the knowledge level of that learner for that particular question. If the learner answers the question confidently and correctly (CC), the knowledge state is deemed “proficient” at 304. If the learner answers with doubt but correct, the knowledge state is deemed “informed” at 306. If the learner answers that he is not sure, the knowledge state is deemed “not sure” at 308. If the learner answers with doubt and is incorrect, the knowledge state is deemed “uninformed” at 310. Finally, if the learner answers confidently and is incorrect, the knowledge state is deemed “misinformed” at 312.

With reference to FIG. 7B, a direct scoring algorithm is shown. The left portion of the direct scoring algorithm 400 is similar to the assessment algorithm 300 with the initial response categories mapping to a corresponding assessment state designation. With reference first to FIG. 7B, an assessment state algorithm 400 is displayed where an initially unseen question (UNS) is presented to a learner at 402. Depending on the response from the learner, an assessment is made as to the knowledge level state of that learner for that particular question. If the learner answers the question confidently and correctly (CC), the knowledge state is deemed “proficient” at 404. If the learner answers with doubt but correct, the knowledge state is deemed “informed” at 406. If the learner answers that he is not sure, the knowledge state is deemed “not sure” at 408. If the learner answers with doubt and is incorrect, the knowledge state is deemed “uninformed” at 410. Finally, if the learner answers confidently and is incorrect, the knowledge state is deemed “misinformed” at 412. In the algorithm described in FIG. 7B, when the same response is given twice for a particular question, the assessment state designation does not change and the learner is determined to have the same knowledge level for that particular question.

With reference to FIG. 7C, a one-time correct proficiency algorithm is shown. In FIG. 7C, an assessment of a learner's knowledge is determined by subsequent answers to the same question. As in FIGS. 7A and 7B an initial question is posed at 502 and based on the response to that question, the learner's knowledge state is deemed either “proficient” at 504, “informed” at 506, “not sure” at 508, “uninformed” at 510 or “misinformed” at 512. The legend for each particular response in FIG. 7C is similar to that in the previous algorithmic processes and as labeled in FIG. 7A. Based on the first response classification, a learner's subsequent answer to that same question will shift the learner's knowledge level state according to the algorithm disclosed in FIG. 7C. For example, referring to an initial question response that is confident and correct (CC) and therefore gets classified as “proficient” at step 504, if a user subsequently answers that same question as confident and incorrect, the assessment state of that user's knowledge of that particular question goes from proficient at 504 to uninformed at 520. Following the scheme set forth in FIG. 7C, if that learner were to answer “not sure” the assessment state would then be classified as “not sure” at 518. The change in assessment state status factors in the varied answers to the same question. FIG. 7C details out the various assessment state paths that are possible with the various answer sets to a particular question. As another example shown in FIG. 7C, if a learner first answers “misinformed” at 512 and then subsequently answers “confident and correct” the resulting assessment state would move to “informed” at 516. Because FIG. 7C lays out a “proficiency” testing algorithm, it is not possible to obtain the “mastery” state 524.

With reference to FIG. 7D, a twice correct mastery algorithm 600 is shown. Similar to FIG. 7C, the algorithm 600 shows a process for knowledge assessment that factors in multiple answers to the same question. As in prior figures an initial question is posed at 602 and based on the response to that question, the learner's knowledge state is deemed either “proficient” at 604, “informed” at 606, “not sure” at 608, “uninformed” at 610 or “misinformed” at 612. The legend for each particular response in FIG. 7D is similar to that in the previous algorithmic processes and as labeled in FIG. 7A. Based on the first response classification, a learner's subsequent answer to that same question will shift the learner's knowledge level state according to the algorithm disclosed in FIG. 7D. With FIG. 7D an additional “mastery” state of knowledge assessment is included at points 630 and 632 and can be obtained based on various question and answer scenarios shown in the flow of FIG. 7D. As one example, a question is presented to a learner at 602. If that question is answered “confident and correct” the assessment state is deemed as “proficiency” at 604. If that same question is subsequently answered “confident and correct” a second time, the assessment state moves to “mastery” at 632. In this example the system recognizes that a learner has mastered a particular fact by answering “confident and correct” twice in a row. If the learner first answers the question presented at 602 as “doubt and correct” and thus the assessment state gets classified as “informed” at 606, in order to achieve “mastery” he would need to answer the question again as “confident and correct” twice in a row after that in order to have the assessment state classified as “mastery.” FIG. 7D details out the various assessment paths that are possible with the various answer sets to a particular question.

In the example of FIG. 7D, there are several possible paths to the “mastery” knowledge state but in each of these it is required to answer a particular ampUnit correctly and confidently twice in row. In one scenario, if a learner is already at a state of mastery of a particular question, and then answers that question other than “confident and correct” the knowledge state will be demoted to one of the other states, depending on the specific answer given. The multiple paths to mastery depending on the learner response to any given question creates an adaptive, personalized assessment and learning experience for each user.

In each of the embodiments discussed above, an algorithm is implemented that performs the following general steps:
1) identifies a goal state configuration as defined by the author,
2) categorizes the learner progress against each question in each round of learning relative to the goal state using the same categorization structure, and
3) displays an ampUnit in the next round of learning dependent on the categorization of the last response to the questions in that ampUnit.

More details and embodiments of the operation of these algorithms are as follows:

Identification of a goal state configuration: The author of a given knowledge assessment may define various goal states within the system in order to arrive at a customized knowledge profile and to determine whether a particular ampUnit (e.g. question) is deemed as being complete. The following are additional examples of these goal states as embodied by the algorithmic flow charts described above and in conjunction with FIGS. 7A-7D:
a. 1 time Correct (Proficiency)—the learner must answer “confident+correct” one time before the ampUnit is deemed as being complete. If the learner answers “confident+incorrect” or “partially sure+incorrect”, the learner must answer confident+correct 2 times before the ampUnit is deemed as being complete.
b. 2 times correct (Mastery)—the learner must answer “confident and correct” twice before the ampUnit is deemed as being complete. If the learner answers “confident+incorrect” or “partially sure+incorrect” the learner must answer “confident+correct” 3 times before the ampUnit is deemed as being complete. As an administrator or test author preference, once an ampUnit is labeled as “complete” per one of the above scenarios it can then be removed from further testing rounds.

Categorizing learner progress: Certain aspects of the system are adapted to categorize the learner's progress against each question in each round of learning, relative to the goal state (described above) using similar categorization structures as described herein, e.g. “confident+correct”, “confident+incorrect”, doubt+correct”, “doubt+incorrect” and “not sure.”

Subsequent Display of ampUnits: The display of an ampUnit in a next round of learning is dependent of the categorization of the last response to the question in that ampUnit relative to the goal state. For example, a “confident+incorrect” response has the highest likelihood that it will be displayed in the next round of learning.

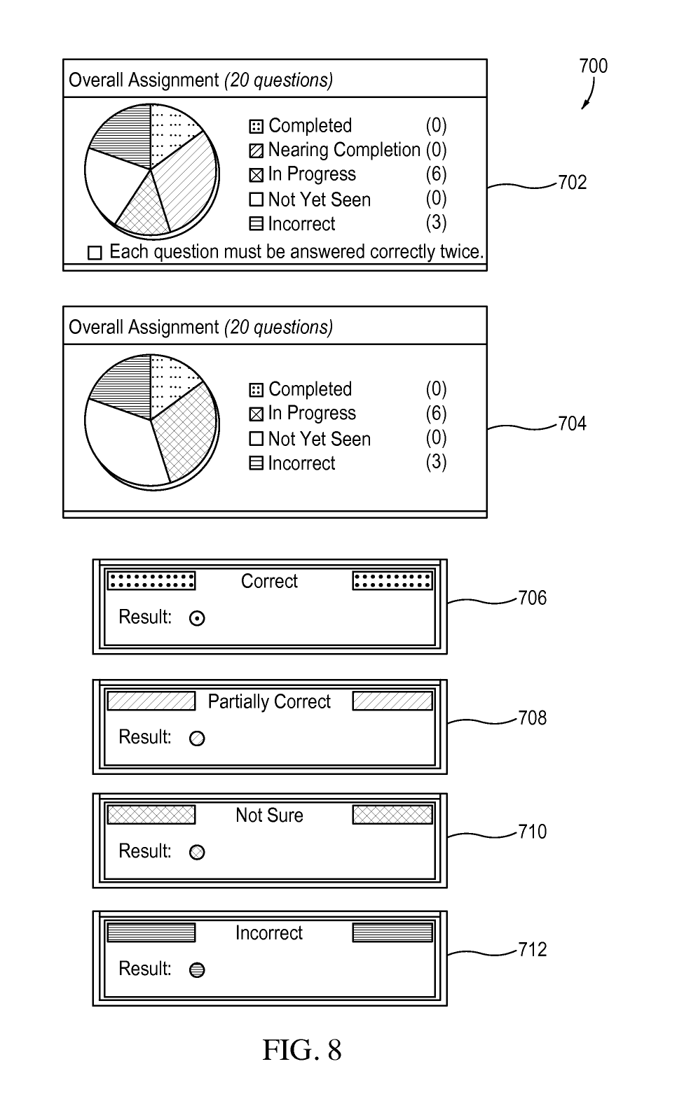

Documenting the Knowledge Profile—In another embodiment, the documented knowledge profile is based on one or more of the following pieces of information. 1) the configured goal state of the test (e.g. mastery versus proficiency) as set by the author of the assessment; 2) the results of the learner's assessment in each round of learning, or within a given assessment; and 3) how the learner's responses are scored by the particular algorithm being implemented. As needed or desired, the knowledge profile may be made available to the learner and other users. Again, this function is something that may be selectively implemented by the assessment author or other administrator of the system. FIG. 8 illustrates several examples of a displayed knowledge profile that may be generated as a result of an assessment being completed by a user. A separate algorithm is utilized in some embodiments to generate the knowledge profile and may be based on the features described above or on a simple list of response percentages separated by categories of responses. In FIG. 8, charts 702 and 704 illustrate overall knowledge profiles that may be delivered to a learner showing the breakdown of a 20 question assignment and the progress made with respect to each category of learning. Instant feedback for any particular question given by a learner can be given in the form shown in 706, 708, 710 and 712.

System Roles—In further embodiments, in addition to the system roles stated above (subject/end-user, content developer, administrator and a help desk) there are also contemplated to be roles such as learner, author, registrar, and analyst.

### Example of Functional Steps

In one embodiment the following steps are utilized in the execution of an assessment. One or more of the steps set forth below may be effected in any order:
a. The author plans and develops the ampUnit(s).
b. The ampUnits are aggregated into modules (ampModules).
c. The ampModules are aggregated into higher order containers. These containers may optionally be classified as courses or programs.
d. The developed curriculum is tested to ensure proper functionality.
e. The curriculum is published and made available for use.
f. One or more learners are enrolled in the curriculum.
g. The learner engages in the assessment and/or learning as found in the curriculum.
h. The learning can be chunked or otherwise grouped so that in a given module the learner will experience both an assessment and a learning phase to each round of learning.
i. A personalized or otherwise adaptive knowledge profile is developed and displayed for each learner on an iterative basis for each round of learning, with the questions and associated remediation provided in each round of learning being made available in a personalized, adaptive manner based on the configuration of the ampModule and how that configuration modifies the underlying algorithm.
j. During the assessment phase, a proficiency or mastery score is shown to the learner after completion of a module.
k. During the learning phase immediate feedback is given to the learner upon submission of each answer.
l. Feedback is given regarding knowledge quality (categorization) after completion of each round of assessment within a round.
m. Feedback is given regarding knowledge quality (categorization) across all rounds completed to date and progress towards proficiency or mastery in any given ampModule.
n. The learner is then presented with an adaptive, personalized set of ampUnits per ampModule per round of learning dependent on he/she answers the questions associated with each ampUnit. The adaptive nature of the system is controlled by a computer implemented algorithm that determines how often a learner will see ampUnits based on the learner's response to those ampUnits in previous rounds of learning. This same knowledge profile is captured in a database and later copied to a reporting database.

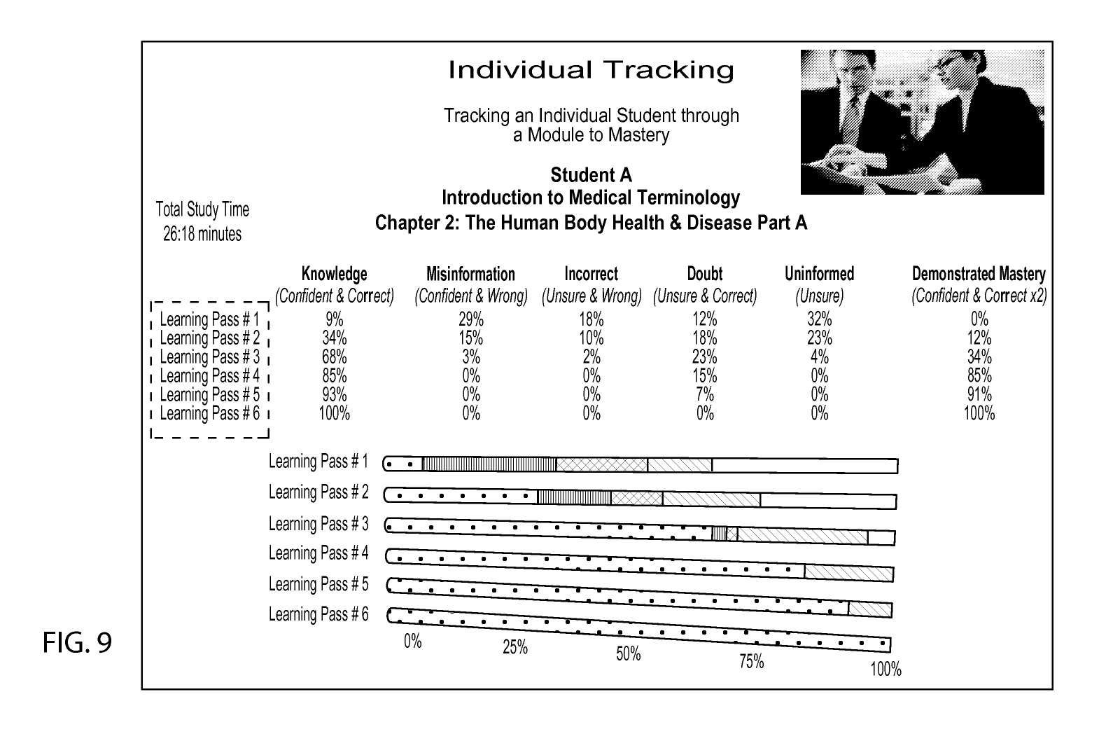

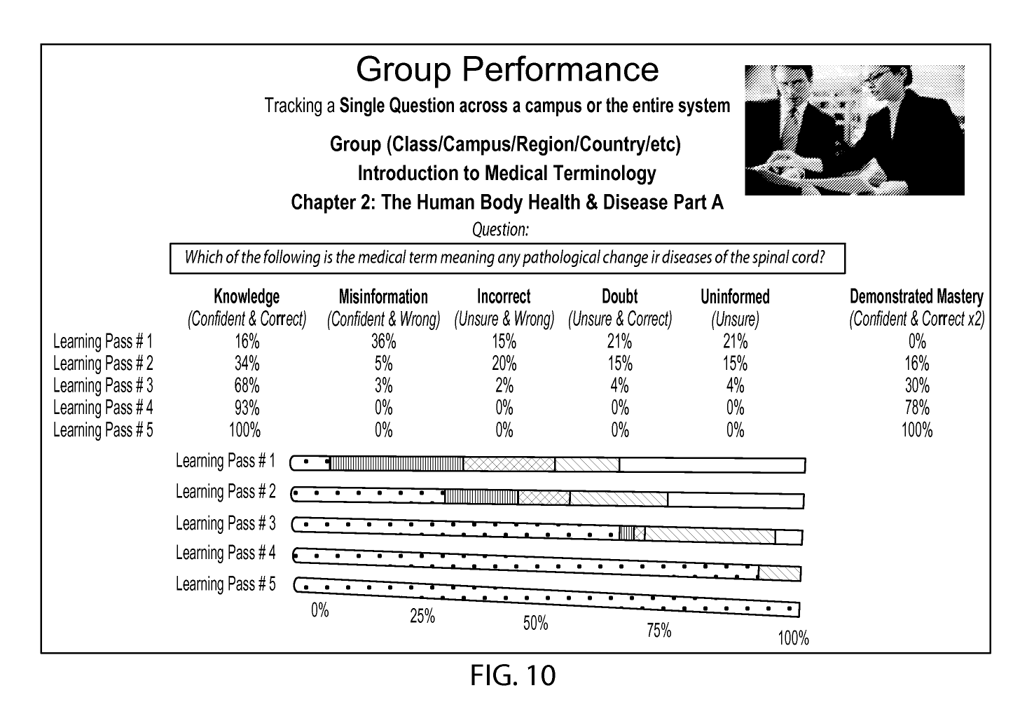

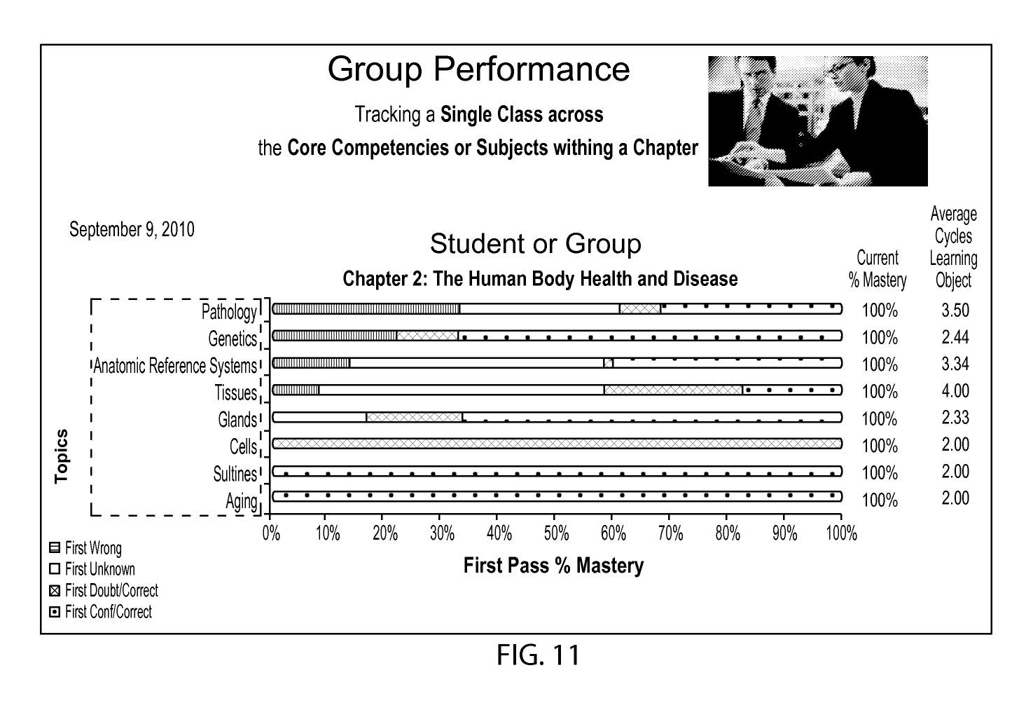

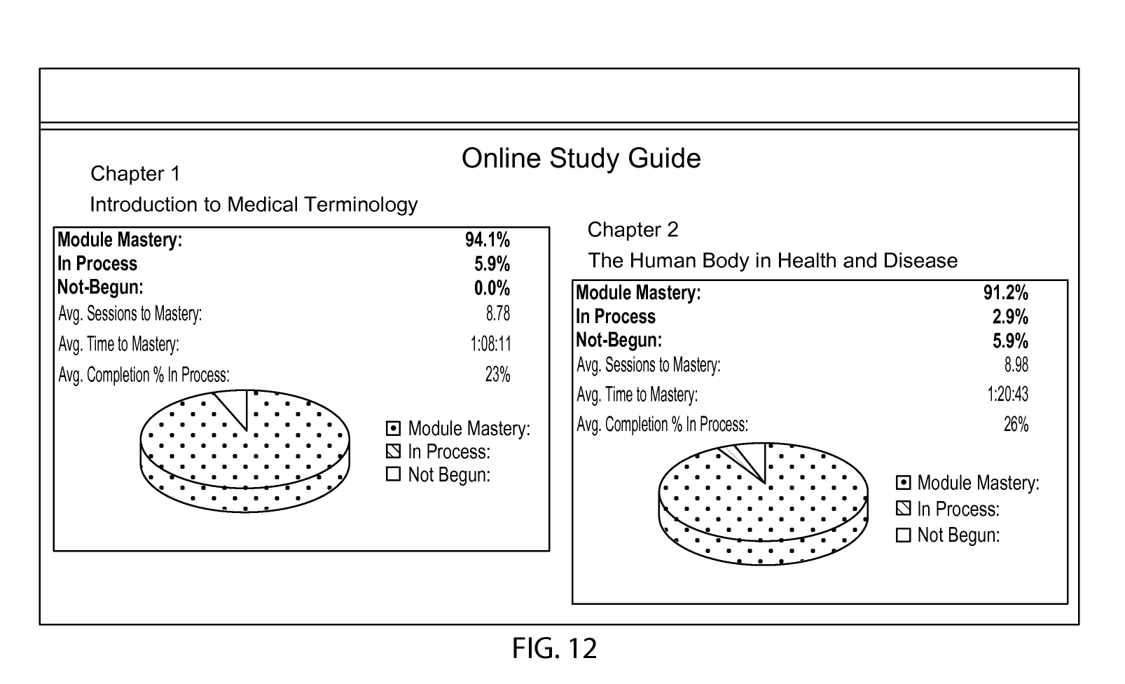

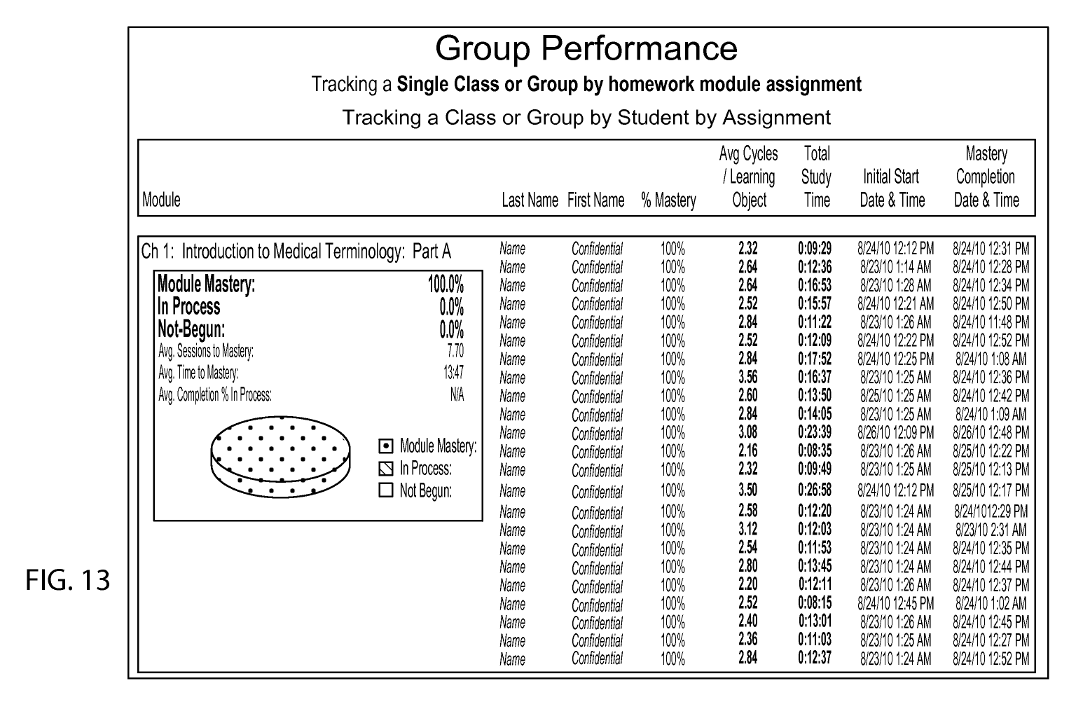

In accordance with another aspect, reports can be generated from the knowledge profile data for display in varied modalities to learners or instructors. A learner can undertake review of any module that has been completed and can undertake a refresher of any modules that has been completed. The system may be configured whereby a learner can receive a certificate documenting achievement of the goals associated with that module as established by the author. FIGS. 9-13 illustrate various exemplary reports that can be utilized to convey progress in a particular assignment or group of assignments. FIG. 9 shows the tracking of an individual student through a learning module to the point of mastery. FIG. 10 shows the tracking of a single question across a campus of individuals (group) through to the point of mastery. FIG. 11 shows the tracking of a single class across specific core competencies. FIG. 12 shows a summary of an online study guide broken down by chapters. FIG. 13 shows the tracking of a single class or group by modules assignment.

Hardware and Machine Implementation. As described above, the system described herein may be implemented in a variety of stand-alone or networked architectures, including the use of various database and user interface structures. The computer structures described herein may be utilized for both the development and delivery of assessments and learning materials and may function in a variety of modalities including a stand-alone system, network distributed (via the world wide web or the internet). In addition, other embodiments include the use of multiple computing platforms and computer devices.

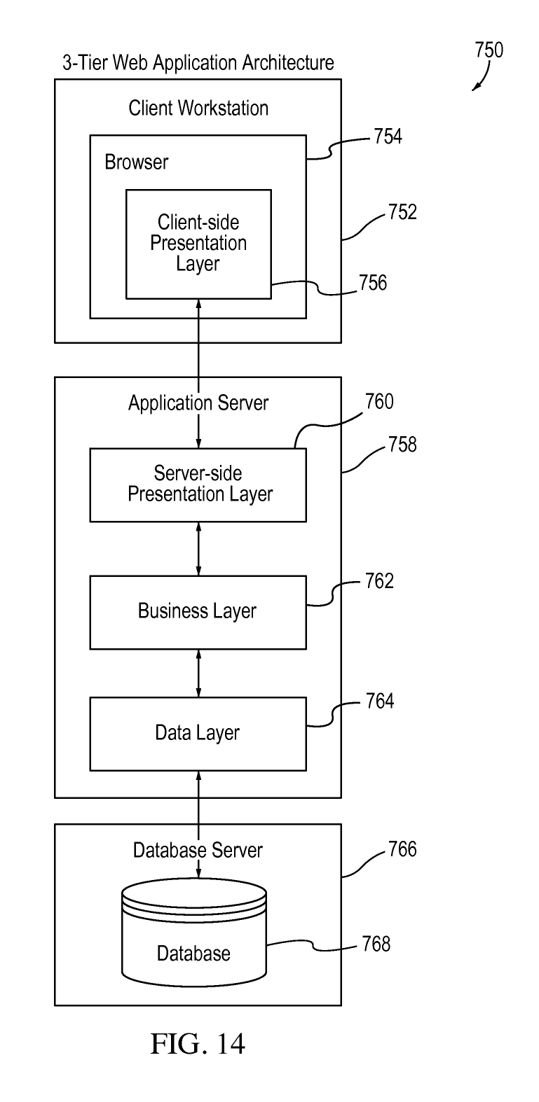

Tiered System Architecture—In one embodiment, the system uses a three-tiered architecture comprised of a user interface layer, a presentation layer, and a database layer each of which are bound together through libraries. FIG. 14 illustrates a system architecture diagram 750 that may be implemented in accordance with one aspect of the present invention. The web application architecture 750 is one structural embodiment that may serve to implement the various machine oriented aspects of devices and system constructed in accordance with the present invention. The architecture 750 consists of three general layers, a presentation layer, a business logic layer and a data abstraction and persistence layer. As shown in FIG. 19, a client workstation 752 runs a browser 754 or other user interface application that itself includes a client-side presentation layer 756. The client workstation 752 is connected to an application server 758 that includes a server-side presentation layer 760, a business layer 762 and a data layer 764. The application server 758 is connected to a database server 766 including a database 768.

FIG. 15 illustrates a diagrammatic representation of one embodiment of a machine in the form of a computer system 900 within which a set of instructions for causing a device to perform any one or more of the aspects and/or methodologies of the present disclosure may be executed. Computer system 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Memory 910 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 920 (BIOS), including basic routines that help to transfer information between elements within computer system 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof.

Computer system 900 may also include a storage device 930. Examples of a storage device (e.g., storage device 930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 may be removably interfaced with computer system 900 (e.g., via an external port connector (not shown)). Particularly, storage device 930 and an associated machine-readable medium 935 may provide nonvolatile and/or volatile storage of machine-readable instructions, data structures, program modules, and/or other data for computer system 900. In one example, software 925 may reside, completely or partially, within machine-readable medium 935. In another example, software 925 may reside, completely or partially, within processor 905. Computer system 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch-screen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof.

A user may also input commands and/or other information to computer system 900 via storage device 930 (e.g., a removable disk drive, a flash drive, etc.) and/or a network interface device 945. A network interface device, such as network interface device 945 may be utilized for connecting computer system 900 to one or more of a variety of networks, such as network 950, and one or more remote devices 955 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 950, may employ a wired and/or a wireless mode of communication. In general, any network topology may be used. Information (e.g., data, software 925, etc.) may be communicated to and/or from computer system 900 via network interface device 945.

Computer system 900 may further include a video display adapter 960 for communicating a displayable image to a display device, such as display device 965. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof. In one example an audio device may provide audio related to data of computer system 900 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 965. Accordingly, a digitizer may be integrated with display device 965, or may exist as a separate device overlaying or otherwise appended to display device 965. Display devices may also be embodied in the form of tablet devices with or without touch-screen capability.

Chunked Learning—In accordance with another aspect, the author of an assessment can configure whether or not the ampUnits are chunked or otherwise grouped so that only a portion of the total ampUnits in a give module are presented in any given round of learning. All “chunking” or grouping is determined by the author in a module configuration step. In this embodiment there is also an option to remove the completed ampUnits based on the assigned definition of “completed.” For example, completed may differ between once correct and twice correct depending of the goal settings assigned by the author or administrator.

ampUnit Structure—ampUnits as described herein are designed as “reusable learning objects” that manifest one or more of the following overall characteristics: A competency statement (learning outcome statement or learning objective); learning required to achieve that competency; and an assessment to validate achievement of that competency. The basic components of an ampUnit include: an introduction; a question, the answers (1 correct, 2 incorrect), an explanation (the need to know information); an option to “expand your knowledge” (the nice to know information), metadata (through the metadata, the author has the capability to link competency to the assessment and learning attributable to each ampUnit which has significant benefits to downstream analysis); and author notes. Using a Content Management System (“CMS”), these learning objects (ampUnits) can be rapidly re-used in current or revised form in the development of learning modules (ampModules).

ampModule Structure—ampModules serve as the “container” for the ampUnits as delivered to the user or learner and are therefore the smallest available organized unit of curriculum that a learner will be presented with or otherwise experience. As noted above, each ampModule preferably contains one or more ampUnits. In one embodiment it is the ampModule that is configured according to the algorithm. An ampModule can be configured as follows:
a. Goal State—this may be set as a certain number of correct answers, e.g. once correct or twice correct, etc.
b. Removal of Mastered (Completed) questions—once a learner has reached the goal state of a particular question, it can be removed from the ampModule and is no longer presented to the learner.
c. Display of ampUnits—the author or administrator can set whether the entire list of ampUnits are displayed in each round of questioning or whether only a partial list is displayed in each round.
d. Completion Score—the author or administrator can set the point at which the learner is deemed to have completed the round of learning, for example, by the achievement of a particular score.
e. Read/Write permissions—these may be set by the author or other design group that is designing the ampUnits.

Curriculum Structure—In certain embodiments, the author or administrator has the ability to control the structure of how the curriculum is delivered to the learner. For example, the program, course, and modules may be renamed or otherwise modified and restructured. In addition, ampModules can be configured to be displayed to the learner as a stand-alone assessment (summative assessment), or as a learning module that incorporates both the assessment and learning capabilities of the system.

### Learner Dashboard

As a component of the systems described herein, a learner dashboard is provided that displays and organizes various aspects of information for the user to access and review. For example, a user dashboard may include one or more of the following:

My Assignments Page—this includes in one embodiment a list of current assignments with one or more of the following status states: Start assignment, Continue Assignment, Review, Start Refresher, Continue Refresher, Perform Review. Also included in the assignments page is Program, Course and Module Information including general information about the aspects of the current program. The assignments page may also include pre and post requisite lists such as other courses that may need to be taken in order to complete a particular assignment or training program. A refresher course will present, via a different algorithm, only a selected group of ampUnits focused on those that the learner needs to spend more time on. A review module will show the track of the progress of a particular learner through a given assessment or learning module (a historical perspective for assessments or learning modules taken previously).

Learning Page—this may include progress dashboards displayed during a learning phase (including both tabular and graphical data). The learning page may also include the learner's percentage responses by category, the results of any prior round f learning and the results across all rounds that have been completed.

Assessment Page—this page may include a progress dashboard displayed after assessment (both tabular and graphical data).

Reporting and Time Measurement—A reporting role is supported in various embodiments. In certain embodiments, the reporting function may have its own user interface or dashboard to create a variety of reports based on templates available within the system. Customized report templates may be created by an administrator and made available to any particular learning environment. Other embodiments include the ability to capture the amount of time required by the learner or learner to answer each ampUnit and answer all ampUnits in a given ampModule. Time is also captured for how much time is spent reviewing the answers. See FIG. 13. Patterns generated from reporting can be generalized and additional information gleaned from the trending in the report functions. See FIGS. 9-13. The reporting functions allow administrators or teachers to figure out where to best spend time in further teaching.

Automation of Content Upload—In accordance with other aspects, the systems described herein may be adapted to utilize various automated methods of adding ampUnits or ampModules. Code may be implemented within the learning system to read, parse and write the data into the appropriate databases. The learning system may also enable the use of scripts to automate upload from previously formatted data e.g. from csv or xml into the learning system. In addition, a custom-built rich-text-format template can be used to capture and upload the learning material directly into the system and retain formatting and structure.

Preferably, the learning system supports various standard types of user interactions used in most computer applications, for example, context-dependent menus appear on a right mouse click, etc. The system also preferably has several additional features such as drag and drop capabilities and search and replace capabilities.

Data Security—Aspects of the present invention and various embodiments use standard information technology security practices to safeguard the protection of proprietary, personal and/or other types of sensitive information. These practices include (in part) application security, server security, data center security, and data segregation. For example, for application security, each user is required to create a manage a password to access his/her account; the application is secured using https; all administrator passwords are changed on a repeatable basis and the passwords must meet strong password minimum requirements. For example, for server security, all administrator passwords are changed every three months with a new random password that meet strong password minimum requirements, and administrator passwords are managed using an encrypted password file. For data segregation, the present invention and its various embodiments use a multi-tenant shared schema where data is logically separated using domain ID, individual login accounts belong to one and only one domain, including Knowledge Factor administrators, all external access to the database is through the application, and application queries are rigorously tested.

### Switches

A learning system constructed in accordance with aspects of the present invention uses various “Switches” in its implementation in order to allow the author or other administrative roles to ‘dial up’ or ‘dial down’ mastery that learner's must demonstrate to complete the modules. The functionality associated with these Switches is based on relevant research in experimental psychology. The various switches incorporated into the learning system described herein are expanded upon below. The implementation of each will vary depending on the particular embodiment and deployment configuration of the present invention.

Repetition—An algorithmically driven repetition switch is used to enable iterative rounds of questioning to a learner in order to achieve mastery. In the classical sense, repetition enhances memory through the purposeful and highly configurable delivery of learning through iterative rounds. The repetition switch uses formative assessment techniques and are in some embodiments combined with the use of questions that do not have forced-choice answers. Repetition in the present invention and various embodiments can be controlled by enforcing, or not enforcing, repetition of assessment and learning materials to the end-user, the frequency of that repletion, and the degree of chunking of content within each repetition.

Priming—Pre-testing aspects are utilized as a foundational testing method in the system. Priming through pre-testing gives some aspect of knowledge memory traces that is then reinforced through repetitive learning. Learning using aspects of the present invention opens up a memory trace with some related topic, and then reinforces that pathway and creates additional pathways for the mind to capture specific knowledge. The priming switch can be controlled in a number of ways in the present invention and its various embodiments, such as through the use of a formal pre-assessment, as well as in the standard use of formative assessment during learning.

Feedback—A feedback loop switch includes both immediate feedback upon the submission of an answer as well as detailed feedback in the learning portion of the round. Immediate reflection to the learner as to whether he/she got a question right or wrong has a significant impact on performance as demonstrated on post-learning assessments. The feedback switch in the present invention and various embodiments can be controlled in a number of ways, such as through the use of both summative assessments combined with standard learning (where the standard learning method incorporates formative assessment), or the extent of feedback provided in each ampUnit (e.g., providing explanations for both the correct and incorrect answers, versus only for the correct answers).

Context—A context switch allows the author or other administrative roles to remove images or other information that is not critical to the particular question. The context switch in the present invention or various embodiments enables the author or administrator to make the learning and study environment reflect as closely as possible the actual testing environment. For example, images and other graphical aspects may be included in earlier learning rounds but then removed to simulate a testing or actual work environment that will not include those same image references. The image or other media may be placed in either the introduction or in the question itself and may be deployed selectively during the learning phase or routinely as part of a refresher. In practice, if the learner will need to recall the information without the help of a visual aid, the learning system can be adapted to present the questions to the learner without the visual aids at later stages of the learning process. If some core knowledge were required to begin the mastery process, the images might be used at an early stage of the learning process. The principle here is to wean the learner off of the images or other supporting but non-critical assessment and/or learning materials over some time period. In a separate yet related configuration of the context switch, the author can determine what percentage of scenario-based learning is required in a particular ampUnit or ampModule.

Elaboration—This switch has various configuration options. For example, the elaboration switch allows the author to provide simultaneous assessment of both knowledge and certainty in a single response across multiple venues and formats. Elaboration may consist of an initial question, a foundational type question, a scenario-based question and a simulation-based question. This switch provides simultaneous selection of the correct answer (recognition answer type) and the degree of confidence. It also provides a review of the explanation of both correct and incorrect answers. This may be provided by a text-based answer, a media-enhanced answer or a simulation-enhanced answer. Elaboration provides additional knowledge that supports the core knowledge and also provides simple repetition for the reinforcement of learning. This switch can also be configured to once correct (proficiency) or twice correct (Mastery) levels of learning. In practice, the information being currently tested is associated with other information that the learner might already know or was already tested on. When thinking about something you already know, you can associate this bit of learning to elaborate and amplify the piece of information you are trying to learn.

Spacing—A Spacing switch in accordance with aspects of the present invention and various embodiments utilizes the manual chunking of content into smaller sized pieces that allow biological processes that support long term memory to take place (e.g. protein synthesis), as well as enhanced encoding and storage. This synaptic consolidation relies on a certain amount of rest between testing and allows the consolidation of memory to occur. The spacing switch can be configured in multiple ways in the various embodiments of the invention, such as setting the number of ampUnits per round and/or the number of ampUnits per module.

Certainty—A certainty switch allows the simultaneous assessment of both knowledge and certainty in a single response. This type of assessment is important to a proper evaluation of a learner's knowledge profile and overall stage of learning. The certainty switch in accordance with aspects of the present invention and various embodiments can be formatted with a configuration of once correct (proficient) or twice correct (mastery).

Attention—An attention switch in accordance with aspects of the present invention and various embodiments requires that the learner provide a judgment of certainty in his/her knowledge (i.e. both emotional and relational judgments are required of the learner). As a result, the learner's attention is heightened. Chunking can also be used to alter the degree of attention required of the learner. For example, chunking of the ampUnits (the number of ampUnits per ampModule, and the number of ampUnits displayed per round) focuses the learner's attention on the core competencies and associated learning required to achieve mastery in a particular subject.

Motivation—A motivation switch in accordance with aspects of the present invention and various embodiments enables a learner interface that provides clear directions as to the learner's progress within one or more of the rounds of learning within any given module, course or program. The switch in the various embodiments can display to the learner either qualitative (categorization) or quantitative (scoring) progress results to each learner.

### Registration

Aspects of the present invention and various embodiments include a built-in registration capability whereby user accounts can be added or deleted from the system, users can be placed in an ‘active’ or ‘inactive’ state, and users (via user accounts) can be assigned to various assessment and learning programs in the system.

### Learning Management System Integration

Aspects of the present invention and various embodiments have the capability of operating as a stand-alone application or can be technically integrating with third-party Learning Management Systems (“LMS”) so that learners that have various assessment and learning assignments managed in the LMS can launch and participate in assessment and/or learning within the system with or without single sign-on capability. The technical integration is enabled through a variety of industry standard practices such as Aviation Industry CBT Committee (AICC) interoperability standards, http posts, web services, and othersuch standard technical integration methodologies.

### Flash Cards

A simple flash card like interface is used in some embodiments of the system to clearly identify and present to the learner the answer(s) selected by the learner, the correct answer, and high-level and/or detailed explanations for the correct answer and (optionally) the incorrect answers. In addition, that same flash card interface can be used to present additional learning opportunities for the learner for that particular learning outcome or competency.

### Avatar

In various embodiments of the system, an avatar with succinct text messages is displayed to provide guidance to the learner on an as-needed basis. The nature of the message, and when or where the avatar is display, is configurable by the administrator of the system. It is recommended that the avatar be used to provide salient guidance to the user. For example, the avatar can be used to provide guidance regarding how the switches describe above impact the learning from the respect of the learner. In the present invention, the avatar is displayed only to the learner, not the author or other administrative roles in the system.

Structure of ampUnit Libraries and Assignments

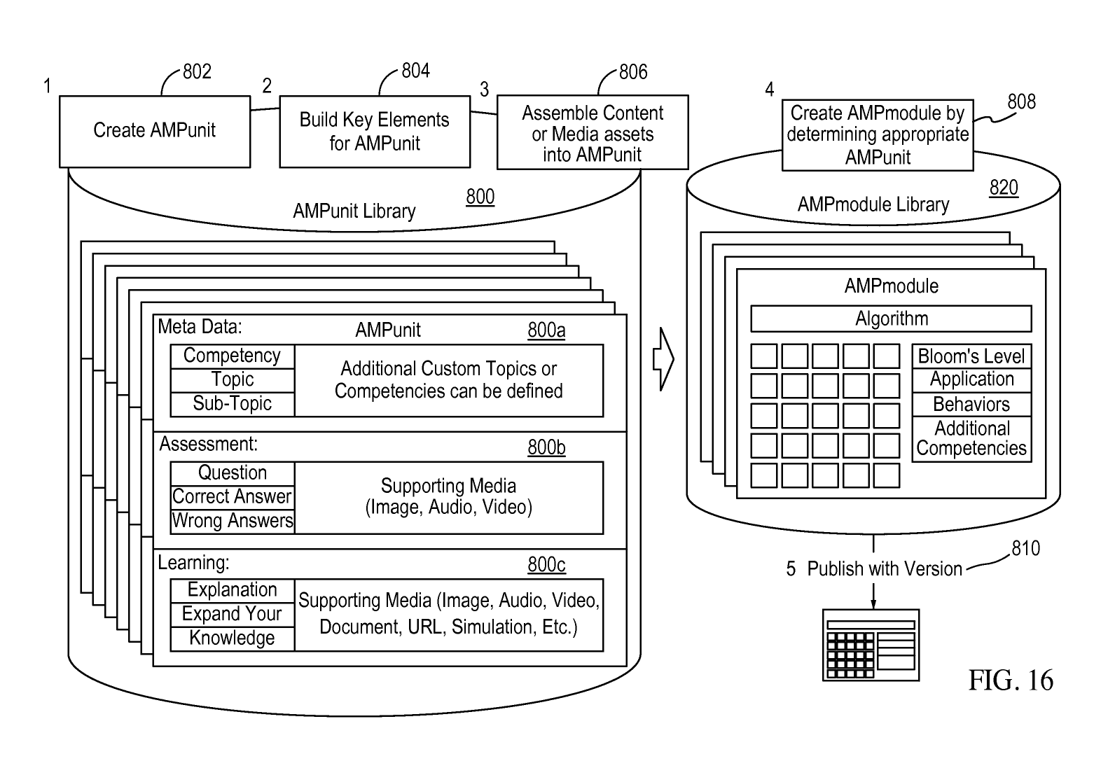

FIG. 16 illustrates the overall structure of an ampUnit library constructed in accordance with aspects of the present invention. In one embodiment, an ampUnit library 800 comprises a meta data component 800a, an assessment component 800b and a learning component 800c. The meta data component 800a is divided into sections related to configurable items that the author desires to be associated with each ampUnit, such as competency, topic and sub-topic. In addition to the meta data component, the Assessment component 800b is divided into sections related to an introduction, the question, a correct answer, and wrong answers. The learning component 800c is further divided into an explanation section and an expand your knowledge section.

Also included is an ampModule library 820 that contains the configuration options for the operative algorithms as well as information relating to a Bloom's level, the application, behaviors, and additional competencies. An administrator or author may utilize these structures in the following manner. First, an ampUnit is created at 802, key elements for the ampUnit are built at 804, the content and media is assembled into an ampUnit at 806. Once the ampUnit library 800 is created the ampModule 820 is created at 808 by determining the appropriate ampUnits to include in the ampModule. After the ampModule is created, the learning assignment is published at 810.

### Industry Applications

1. Certification

The confidence-based assessment can be used as a confidence-based certification instrument, both as a pre-test practice assessment, and as a learning instrument. In this instance or a pre-test assessment, the confidence-based certification process would not provide any remediation but only provide a score and/or knowledge profile. The confidence-based assessment would indicate whether the individual had any confidently held misinformation in any of the certification material being presented. This would also provide, to a certification body, the option of prohibiting certification where misinformation exists within a given subject area. Since the CBA method is more precise then current one-dimensional testing, confidence-based certification increases the reliability of certification testing and the validity of certification awards. In the instance where the system is used as a learning instrument, the learner can be provided the full breadth of formative assessment and learning manifest in the system to assist the learner in identifying specific skill gaps, and filling those gaps remedially.

2. Scenario-Based Learning

The confidence-based assessment can apply to adaptive learning approaches in which one answer generates two metrics with regard to confidence and knowledge. In adaptive learning, the use of video or scenarios to describe a situation helps the individual work through a decision making process that supports their learning and understanding. In these scenario-based learning models, individuals can repeat the process a number of times to develop familiarity with how they would handle a given situation. For scenarios or simulations, CBA and CBL adds a new dimension by determining how confident individuals are in their decision process. The use of the confidence-based assessment using a scenario-based learning approach enables individuals to identify where they are uninformed and have doubts in their performance and behavior. Repeating scenario-based learning until individuals become fully confident increases the likelihood that the individuals will act rapidly and consistently with their training. CBA and CBL are also ‘adaptive’ in that each user interacts with the assessment and learning based on his her own learning aptitude and prior knowledge, and the learning will therefore be highly personalized to each user.

3. Survey

The confidence-based assessment can be applied as a confidence-based survey instrument, which incorporates the choice of three possible answers, in which individuals indicate their confidence in and opinion on a topic. As before, individuals select an answer response from seven options to determine their confidence and understanding in a given topic or their understanding of a particular point of view. The question format would be related to attributes or comparative analysis with a product or service area in which both understanding and confidence information is solicited. For example, a marketing firm might ask, “Which of the following is the best location to display a new potato chip product? A) at the checkout; B) with other snack products; C) at the end of an aisle.” The marketer is not only interested in the consumer's choice, but the consumer's confidence or doubt in the choice. Adding the confidence dimension increases a person's engagement in answering survey questions and gives the marketer richer and more precise survey results.

Further aspects in accordance with the present invention provide learning support where resources for learning are allocated based on the quantifiable needs of the learner as reflected in a knowledge assessment profile, or by other performance measures as presented herein. Thus, aspects of the present invention provide a means for the allocation of learning resources according to the extent of true knowledge possessed by the learner. In contrast to conventional training where a learner is generally required to repeat an entire course when he or she has failed, aspects of the present invention disclosed herein facilitate the allocation of learning resources such as learning materials, instructor and studying time by directing the need of learning, retraining, and reeducation to those substantive areas where the subject is misinformed or uninformed.

Other aspects of the invention effected by the system offers or presents a “Personal Training Plan” page to the user. The page displays the queries, sorted and grouped according to various knowledge regions. Each of the grouped queries is hyper-linked to the correct answer and other pertinent substantive information and/or learning materials on which the learner is queried. Optionally, the questions can also be hyper-linked to online informational references or off-site facilities. Instead of wasting time reviewing all materials encompass the test query, a learner or user may only have to concentrate on the material pertaining to those areas that require attention or reeducation. Critical information errors can be readily identified and avoided by focusing on areas of misinformation and partial information.

To effect such a function, the assessment profile is mapped or correlated to the informational database and/or substantive learning materials, which is stored in system 8 or at off-system facilities such as resources in the World Wide Web. The links are presented to the learner for review and/or reeducation.

In addition, the present invention further provides automated cross-referencing of the test queries to the relevant material or matter of interest on which the test queries are formulated. This ability effectively and efficiently facilitates the deployment of training and learning resources to those areas that truly require additional training or reeducation.

Further, with the present invention, any progress associated with retraining and/or reeducation can be readily measured. Following a retaining and/or reeducation, (based on the prior performance results) a learner could be retested with portions or all of test queries, from which a second knowledge profile can be developed.

In all the foregoing applications, the present method gives more accurate measurement of knowledge and information. Individuals learn that guessing is penalized, and that it is better to admit doubts and ignorance than to feign confidence. They shift their focus from test-taking strategies and trying to inflate scores toward honest self-assessment of their actual knowledge and confidence. This gives subjects as well as organizations rich feedback as to the areas and degrees of mistakes, unknowns, doubts and mastery. Having now fully set forth the preferred embodiments and certain modifications of the concept underlying the present invention, various other embodiments as well as certain variations and modifications of the embodiments herein shown and described will obviously occur to those skilled in the art upon becoming familiar with the underlying concept. It is to be understood, therefore, that the invention may be practiced otherwise than as specifically set forth herein.

What is claimed is:

1. A system for knowledge assessment, comprising:
a display device for displaying to a learner a plurality of multiple-choice questions and two-dimensional answers;
an application server adapted to communicate with the display device via a communications network
a database server comprising a database of learning materials, wherein the plurality of multiple-choice questions and two-dimensional answers are stored in the database for selected delivery to the client terminal, the system performing a method of,
transmitting via the communications network to the display device the plurality of multiple-choice questions and two-dimensional answers thereto, the answers including a plurality of full-confidence answers consisting of single-choice answers, a plurality of partial-confidence answers consisting of one or more sets of multiple single-choice answers, and an unsure answer;
administering an assessment by presenting to the learner via the display device the plurality of multiple-choice questions and the two-dimensional answers thereto, and receiving via the display device the learner's selected answer to the multiple-choice questions by which the learner indicates both their substantive answer and the level of confidence category of their answer;
scoring the assessment by assigning the following knowledge state designations:
a proficient knowledge state in response to a confident and correct answer by the learner;
an informed knowledge state in response to a doubt and correct answer by the learner;
an unsure knowledge state in response to a not sure answer by the learner;
an uninformed knowledge state in response to a doubt and incorrect answer by the learner; and
a misinformed knowledge state in response to a confident and incorrect answer by the learner.

2. The system of claim 1 further comprising,
re-administering the assessment and assigning the following designations:
a proficient knowledge state in response to a second confident and correct answer by the learner following a first confident and correct answer by the learner;
an informed knowledge state in response to a doubt and correct answer by the learner following a confident and correct answer by the learner;
an unsure knowledge state in response to a not sure answer by the learner following a confident and correct answer by the learner;
an unsure knowledge state in response to a doubt and incorrect answer by the learner following a confident and correct answer by the learner; and
an uninformed knowledge state in response to a confident and incorrect answer by the learner following a confident and correct answer by the learner.

3. The system of claim 1 further comprising,
re-administering the assessment and assigning the following designations:
a proficient knowledge state in response to a confident and correct answer by the learner following a doubt and correct answer by the learner;
an informed knowledge state in response to a doubt and correct answer by the learner following a doubt and correct answer by the learner;
an unsure knowledge state in response to a not sure answer by the learner following a doubt and correct answer by the learner;
an uninformed knowledge state in response to a doubt and incorrect answer by the learner following a doubt and correct answer by the learner; and
a misinformed knowledge state in response to a confident and incorrect answer by the learner following a doubt and correct answer by the learner.

4. The system of claim 1 further comprising,
re-administering the assessment and assigning the following designations:
a proficient knowledge state in response to a confident and correct answer by the learner following a not sure answer by the learner;
an informed knowledge state in response to a doubt and correct answer by the learner following a not sure answer by the learner;
an unsure knowledge state in response to a not sure answer by the learner following a not sure answer by the learner;
an uninformed knowledge state in response to a doubt and incorrect answer by the learner following a not sure answer by the learner; and
a misinformed knowledge state in response to a confident and incorrect answer by the learner following a not sure answer by the learner.

5. The system of claim 1 further comprising,
re-administering the assessment and assigning the following designations:
a proficient knowledge state in response to a confident and correct answer by the learner following a doubt and incorrect answer by the learner;
an informed knowledge state in response to a doubt and correct answer by the learner following a doubt and incorrect answer by the learner;
an unsure knowledge state in response to a not sure answer by the learner following a doubt and incorrect answer by the learner;
a misinformed knowledge state in response to a doubt and incorrect answer by the learner following a doubt and incorrect answer by the learner; and
a misinformed knowledge state in response to a confident and incorrect answer by the learner following a doubt and incorrect answer by the learner.

6. The system of claim 1 further comprising,
re-administering the assessment and assigning the following designations:
an informed knowledge state in response to a confident and correct answer by the learner following a confident and incorrect answer by the learner;
a not sure knowledge state in response to a doubt and correct answer by the learner following a confident and incorrect answer by the learner;
an uninformed knowledge state in response to a not sure answer by the learner following a confident and incorrect answer by the learner;
a misinformed knowledge state in response to a doubt and incorrect answer by the learner following a confident and incorrect answer by the learner; and
a misinformed knowledge state in response to a confident and incorrect answer by the learner following a confident and incorrect answer by the learner.

7. The system of claim 1 further comprising,
re-administering the assessment test and assigning the following designations:
a mastery knowledge state in response to a second confident and correct answer by the learner following a first confident and correct answer by the learner;
am informed knowledge state in response to a doubt and correct answer by the learner following a confident and correct answer by the learner;
a not sure knowledge state in response to a not sure answer by the learner following a confident and correct answer by the learner;
a not sure knowledge state in response to a doubt and incorrect answer by the learner following a confident and correct answer by the learner; and
an uninformed knowledge state in response to a confident and incorrect answer by the learner following a confident and correct answer by the learner.

8. The system of claim 1, further comprising compiling a knowledge profile from the scored CBA comprising a graphical illustration of the learner's level of mastery, proficiency, informed, not sure, uninformed and misinformed answers.

9. The system of claim 8, further comprising:
encouraging remedial learning by the learner by, in association with displaying the knowledge profile to the learner, also displaying the multiple-choice questions to the subject along with one or more of the learner's answer, a correct answer, an explanation, and references to related learning materials for the questions;
re-administering the assessment with a plurality of different multiple-choice questions;
compiling and displaying a composite knowledge profile to the subject from the administered and re-administered assessments.

10. The system of claim 1, wherein the application server and the database server reside at a location remote from the client terminal.

11. The system of claim 1, wherein the application server and the database server reside at a location proximate to the client terminal.

12. The system of claim 1, wherein the application server, the database server, and the client terminal are connected via a wide area network.

13. A method of knowledge assessment, comprising:
displaying to a learner at a display device a plurality of multiple-choice questions and two-dimensional answers;
initiating a communication protocol between an application server and the display device via a communications network
accessing a database server, the database server comprising a database of learning materials, wherein the plurality of multiple-choice questions and two-dimensional answers are stored in the database for selected delivery to the display device, the method for knowledge assessment comprising:
transmitting via the communications network to the display device the plurality of multiple-choice questions and two-dimensional answers, the answers including a plurality of full-confidence answers consisting of single-choice answers, a plurality of partial-confidence answers consisting of one or more sets of multiple single-choice answers, and an unsure answer;
administering an assessment comprising presenting to the learner via the display device the plurality of multiple-choice questions and the two-dimensional answers, and receiving via the display device the learner's selected answers to the multiple-choice questions by which the learner indicates both their substantive answer and the level of confidence category of their answer;
scoring the assessment by assigning the following designations:
a proficient knowledge state in response to a confident and correct answer by the learner;
an informed knowledge state in response to a doubt and correct answer by the learner;
an unsure knowledge state in response to a not sure answer by the learner;
an uninformed knowledge state in response to a doubt and incorrect answer by the learner; and
a misinformed knowledge state in response to a confident and incorrect answer by the learner.

14. A method of knowledge assessment, comprising:
displaying to a learner at a display device a plurality of multiple-choice questions and two-dimensional answers;
accessing a database server, the database server comprising a database of learning materials, wherein the plurality of multiple-choice questions and two-dimensional answers are stored in the database for selected delivery to the display device, the method for knowledge assessment comprising:
transmitting to the display device the plurality of multiple-choice questions and two-dimensional answers, the answers including a plurality of full-confidence answers consisting of single-choice answers, a plurality of partial-confidence answers consisting of one or more sets of multiple single-choice answers, and an unsure answer;
scoring an assessment administered to the learner by assigning the following designations:
a first knowledge state in response to a confident and correct answer by the learner;
a second knowledge state in response to a doubt and correct answer by the learner;
a third knowledge state in response to a not sure answer by the learner;
a fourth knowledge state in response to a doubt and incorrect answer by the learner; and
a fifth knowledge state in response to a confident and incorrect answer by the learner.

15. The method of claim 14, further comprising incorporating one or more algorithmic switches to determine which questions to present to the learner.

16. The method of claim 15, wherein at least one of the switches is a repetition switch.

17. The method of claim 15, wherein at least one of the switches is a priming switch.

18. The method of claim 15, wherein at least one of the switches is a feedback switch.

19. The method of claim 15, wherein at least one of the switches is a context switch.

20. The method of claim 15, wherein at least one of the switches is a retrieval switch.

21. The method of claim 15, wherein at least one of the switches is an elaboration and association switch.

22. The method of claim 15, wherein at least one of the switches is a spacing switch.

23. The method of claim 15, wherein at least one of the switches is a certainty switch.

24. The method of claim 15, wherein at least one of the switches is an attention switch.

25. The method of claim 15, wherein at least one of the switches is a motivation switch.

26. The method of claim 14, wherein the first knowledge state is proficient.

27. The method of claim 14, wherein the second knowledge state is informed.

28. The method of claim 14, wherein the third knowledge state is unsure.

29. The method of claim 14, wherein the fourth knowledge state is uninformed.

30. The method of claim 14, wherein the fifth knowledge state is misinformed.

31. The system of claim 1, where the assessment is adapted to provide one or more of learning, training, and personalized adaptive functions to the learner.
